(19) United States
(12) Patent Application Publication
(10) Pub. No.: US 2011/0117353 A1
(43) Pub. Date: May 19, 2011

(54) FIBERS AND ARTICLES HAVING COMBINED FIRE RESISTANCE AND ENHANCED REVERSIBLE THERMAL PROPERTIES

(75) Inventors: Michael Henshaw, Longmont, CO (US); Mark Hartmann, Boulder, CO (US)

(73) Assignee: OUTLAST TECHNOLOGIES, INC., Boulder, CO (US)

(21) Appl. No.: 12/947,973

(22) Filed: Nov. 17, 2010

Related U.S. Application Data
(60) Provisional application No. 61/262,074, filed on Nov. 17, 2009.

(51) Int. Cl. D02G 3/02; B32B 5/02

(52) U.S. Cl. 428/221; 428/364; 428/372

(57) ABSTRACT

A fabric, fiber or article comprising a plurality of fiber bodies, the plurality of fiber bodies including a first fiber material and a second fiber material, wherein the first fiber material comprises a cellulosic material and a phase change material dispersed in the cellulosic material, the phase change material forming a plurality of domains dispersed in the cellulosic material, the phase change material having a latent heat of at least 5 Joules per gram and a transition temperature in the range of 0° C. to 100° C., the phase change material providing thermal regulation based on at least one of absorption and release of the latent heat at the transition temperature. Wherein the second fiber material comprises a fire resistant material.

### PRIORITY AND CROSS REFERENCE TO RELATED APPLICATIONS

The present application claims priority to Provisional U.S. Patent Application No. 61/262,074, entitled Fibers and Articles Having Combined Fire Resistance and enhanced Reversible Thermal Properties, filed on Nov. 17, 2009. The details of this application is incorporated herein by reference in its entirety.

### FIELD OF THE INVENTION

The present invention relates to articles having enhanced reversible thermal properties combined with enhanced fire resistance properties. More particularly, the present invention relates to coated articles or melt, dry, or solution spun fibers with the ability to show such enhanced reversible thermal properties and fire resistance properties while adhering and conforming to various regulatory requirements for fire resistant materials.

### BACKGROUND OF THE INVENTION

Coatings containing a phase change material have been applied to fabrics to provide enhanced reversible thermal properties to the fabrics themselves as well as to garments or other everyday products. Encapsulated or raw non-encapsulated phase change materials are known to be mixed with various materials to form fibers or fabrics. Details of the various embodiments surrounding the use of phase change materials can be found in various patents owned or assigned to Outlast Technologies, Inc. of Boulder, Colo., including U.S. Pat. Nos. 6,207,738, 6,503,976, 6,514,362, 6,660,667, 5,677,048, 5,851,338, 5,955,188, 6,230,444, 6,077,597, 6,217,993, 6,099,894, 6,171,647, 6,855,422, 7,241,497, 7,160,612, 6,689,466, 6,793,856, 7,563,398, 7,135,424, 5,366,801, 4,756,958, 7,244,497, 7,579,078, 6,099,894, 6,171,647, 6,270,836, 6,197,415, 6,696,145, 6,892,478, and 6,179,879. The details of these disclosures are expressly incorporated by reference into this application.

Outlast® brand fibers have been combined in various combinations with other fibers since the first Outlast acrylic fiber, became available on the market. It is also known that certain characteristics in addition to temperature regulation can be achieved by combining Outlast fibers with selected specialty fibers in intimate-blend yarns (i.e., a single yarn bundle with specific ratios of more than one fiber). However, none of these fibers have been able to combine temperature regulating characteristics with fire resistant properties. In that regard an effort was made to make a yarn with both fire resistant (FR) & temperature regulating qualities.

### SUMMARY OF THE INVENTION

In accordance with one aspect a fabric, yarn, fiber or article comprises a plurality of fiber bodies, the plurality of fiber bodies including a first fiber material and a second fiber material, wherein the first fiber material comprises a cellulosic material and a non-encapsulated or encapsulated phase change material dispersed in the cellulosic material. The phase change material forms a plurality of domains dispersed in the cellulosic material, the phase change material has a latent heat of at least 5 Joules per gram and a transition temperature in the range of 0° C. to 100° C., the non-encapsulated phase change material providing thermal regulation based on at least one of absorption and release of the latent heat at the transition temperature. The second fiber material comprises a fire resistant material.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWING FIGURES

For a better understanding of the nature and objects of some embodiments of the invention, reference should be made to the following detailed description taken in conjunction with the accompanying drawings.

FIG. 1 illustrates a three-dimensional view of a cellulosic/modacrylic fiber according to an embodiment of the invention.

FIG. 2 illustrates a three-dimensional view of another fiber according to an embodiment of the invention.

FIG. 3 illustrates cross-sectional views of various fibers according to an embodiment of the invention.

FIG. 4 illustrates cross-sectional views of additional fibers according to an embodiment of the invention.

FIG. 5 illustrates a three-dimensional view of a fiber having a core-sheath configuration, according to an embodiment of the invention.

FIG. 6 illustrates a three-dimensional view of another fiber having a core-sheath configuration, according to an embodiment of the invention.

FIG. 7 illustrates a three-dimensional view of a fiber having an island-in-sea configuration, according to an embodiment of the invention;

FIGS. 8A-8B illustrates various embodiments of yarn structures used in connection with aspects of the present invention; and

FIGS. 9-15 are test results showing the performance characteristics of articles, fabrics and fibers constructed in accordance with aspects of the present invention.

### DETAILED DESCRIPTION

Throughout this specification references are made to the use of various materials, combinations, chemical formulations and other aspects that may be used in various combinations to form one or more materials, end products, fibers, fabrics or compositions in accordance with aspects of the present invention. It should be understood, both to one of skill in the art as well as the examining divisions in the United States Patent Office and Patent Offices throughout the world, that each of the lists of materials, examples, and other embodiments are included herein in order to teach one of skill in the art that they may be combined into various alternative embodiments, without requiring specific claim permutations of these individual features. The claims as presented herein, as well as any potential future amendments to those claims, may include one or more combinations of these materials, ranges and other alternatives without departing from the spirit and scope of the invention described herein. In particular it is contemplated that one of skill in the art would recognize and find adequate support in the written description for any combination of the features disclosed herein, whether described in a single example or embodiment, or described in different sections of the written description. The description of these various example and options is specifically drafted to comply with 35 U.S.C. §112 of the United States Patent Laws, Article 123(2) of the European Patent Laws as well as other similar national country laws relating to the adequacy of the written description.

In accordance with one aspect, various fabrics, yarns fibers and articles constructed in accordance with the disclosure presented herein may be knitted into “no melt-no drip” t-shirts and base-layer underwear intended for use, for example, by members of the U.S. military, police & fire departments, electrical workers, and others who work in environments where burns are a duty hazard.

In one embodiment, a modacrylic fiber is blended with Outlast viscose. Modacrylic fibers have a proven track record of exhibiting fire resistance qualities when incorporated into a fabric or garment. The Outlast viscose material (“rayon”, in one example) is selected because of its cellulose base. Even without the inclusion of the Outlast viscose, rayon is known as a “comfort fiber” with excellent moisture management properties. The Outlast viscose adds the technological advance of temperature regulation to the viscose comfort equation.

In one example, a ratio of 70% modacrylic fiber to 30% Outlast viscose fiber was used as a starting point. In order to achieve various functional end product, the ratio of these materials is changed as necessary. Other requirements include that the fiber should pass the U.S. military's fire resistance standard, and it must exhibit measurable temperature regulation.

Two jersey knits were made from this yarn—one is 4.0 ounces per square yard (osy), 70% modacrylic/30% Outlast Viscose, the other is 5.7 osy, 68% modacrylic/29% Outlast Viscose/3% spandex. In subsequent testing, both fabrics passed ASTM D 6413-99 “Flame Resistance of Textiles (Vertical)”. When compared with a 4.0 osy Control fabric made with 70% modacrylic/30% FR rayon, the ASTM results were virtually identical, with both samples achieving ASTM fire resistance standard. However, the measured results with the Outlast & the control T-shirts tested on human subjects in Outlast's environmental lab show nearly 2° F. cooler skin temperature at 75° F., with correlating subjective results & 34% less sweating. At 46° F., skin temp was almost 2° F. warmer for the Outlast shirt, with correlating subjective results, and substantially less sweating. Without knowing which shirt was being worn, the test subjects invariably selected the Outlast shirts as the most comfortable.

Thus, the goal of achieving both fire resistance & improved comfort was reached. The Outlast shirts were also compared against another brand of fire resistant t-shirts of the same weight in physiological tests, and the test subjects showed a wide margin of preference for the Outlast shirts.

Unique properties that are achieved with the above blends include:
1. “No melt, no drip”, per USMC requirement.
2. No after-flame, per ASTM D 6413-99 testing.
3. Real temperature regulation, as measured by human subject physiological testing.
4. Measurably reduced sweat production in human subject testing.
5. Can be spun into any size yarn, from 40/1 to 9/1, through multiple methods.
6. Yarn can be knitted in many diverse patterns and weights, or woven into shirting or bottom weight fabrics.
7. Ease of dyeing & finishing.
8. Good colorfastness.
9. Good shrinkage control.
10. Durable, stable, abrasion resistant.
11. Antimicrobial “odor control” finish is available.
12. Lower relative humidity inside the shirt next-to-skin.
13. Soft hand, no chafing, very comfortable to wear.

Additional fire resistant fibers that can be blended (or used in place of or in conjunction with the modacrylic fiber) into a fabric or garment include Nomex® and Kevlar® made by Dupont, Twaron® made by Teijin Aramid, FR Rayon® made by Lenzing, PBI® made by PBI Performance Products. In addition, fire resistance treated cotton materials may be used. Further materials include melamine fibers (Basofil), glass fibers (fiber glass), fire resistant polyester from Far Eastern, and Nachly fire resistant fibers, Kermel fire resistant fibers.

PBO (polyphenylenebenzobisozazole) and PI (polyimide) are two other high-temperature fire resistant fibers based on repeating aromatic structures that may be used in conjunction with aspects of the present invention. Both are recent additions to the market. PBO exhibits very good tensile strength and high modulus, which are useful in reinforcing applications. Polyimide's temperature resistance and irregular cross-section make it a good candidate for hot gas filtration applications. Sulfar (PPS, polyphenylene sulfide) exhibits moderate thermal stability but good chemical and fire resistance. It is used in a variety of filtration and other industrial applications.

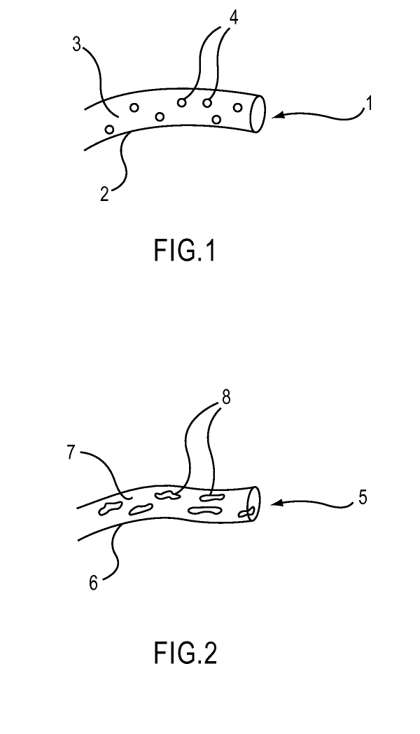

In addition to the fire resistant material, a phase change material can be incorporated into the end product fiber, fabric or garment either into the fiber or by coating. FIGS. 1-8 illustrate various types of fibers, fabrics, and base materials that may incorporate aspects of the present invention relating to combined fire resistance and temperature regulating properties. It should be understood that the fibers referred to in the figure descriptions may include any of the combinations of cellulosic/viscose and modacrylic fire resistant materials described herein.

A cellulosic material can be initially provided in any of various forms, such as, for example, sheets of cellulose, wood pulp, cotton linters, and other sources of substantially purified cellulose. Typically, a cellulosic material is dissolved in a solvent prior to passing through the orifices of the spinneret. In some instances, the cellulosic material can be processed (e.g., chemically treated) prior to dissolving the cellulosic material in the solvent. For example, the cellulosic material can be immersed in a basic solution (e.g., caustic soda), squeezed through rollers, and then shredded to form crumbs. The crumbs can then be treated with carbon disulfide to form cellulose xanthate. As another example, the cellulosic material can be mixed with a solution of glacial acetic acid, acetic anhydride, and a catalyst and then aged to form cellulose acetate, which can precipitate from the solution in the form of flakes. In another embodiment, lyocell fibers are made by dissolving cellulose in morpholine oxide solvents, preferably nMMO or N-Methyl Morpholine Oxide. This dope is then spun or extruded thru an orifice into water to create the lycocell fiber. The foregoing discussion provides a general overview of some embodiments of the invention.

Attention now turns to FIG. 1, which illustrates a three-dimensional view of a cellulosic or viscose fiber 1. As illustrated in FIG. 1, the fiber 1 is a mono-component fiber that includes a single elongated member 2. The elongated member 2 is generally cylindrical and includes a blend of cellulosic material 3 and a temperature regulating material 4 dispersed within the cellulosic material 3. In the illustrated embodiment, the temperature regulating material 4 can include various microcapsules containing a phase change material, and the microcapsules can be substantially uniformly dispersed throughout the elongated member 2. While it may be desirable to have the microcapsules uniformly dispersed within the elongated member 2, such configuration is not necessary in all applications. The cellulosic fiber 1 can include various percentages by weight of the cellulosic material 3 and the temperature regulating material 4 to provide desired thermal regulating properties, mechanical properties (e.g., ductility, tensile strength, and hardness), moisture absorbency, and fire resistant properties.

FIG. 2 illustrates a three-dimensional view of another cellulosic fiber 5 according to an embodiment of the invention. As discussed for the cellulosic fiber 1, the cellulosic fiber 5 is a mono-component fiber that includes a single elongated member 6. The elongated member 6 is generally cylindrical and includes a cellulosic material 7 and a temperature regulating material 8 dispersed within the cellulosic material 7. In the illustrated embodiment, the temperature regulating material 8 can include a phase change material in a raw form (e.g., the phase change material is non-encapsulated, i.e., not micro- or macroencapsulated), and the phase change material can be substantially uniformly dispersed throughout the elongated member 6. While it may be desirable to have the phase change material uniformly dispersed within the elongated member 6, such configuration is not necessary in all applications. As illustrated in FIG. 2, the phase change material can form distinct domains that are dispersed within the elongated member 6. The cellulosic fiber 5 can include various percentages by weight of the cellulosic material 7 and the temperature regulating material 8 to provide desired thermal regulating properties, mechanical properties, and moisture absorbency. As discussed in the examples, various blends of the temperature regulating materials and cellulosic materials are contemplated.

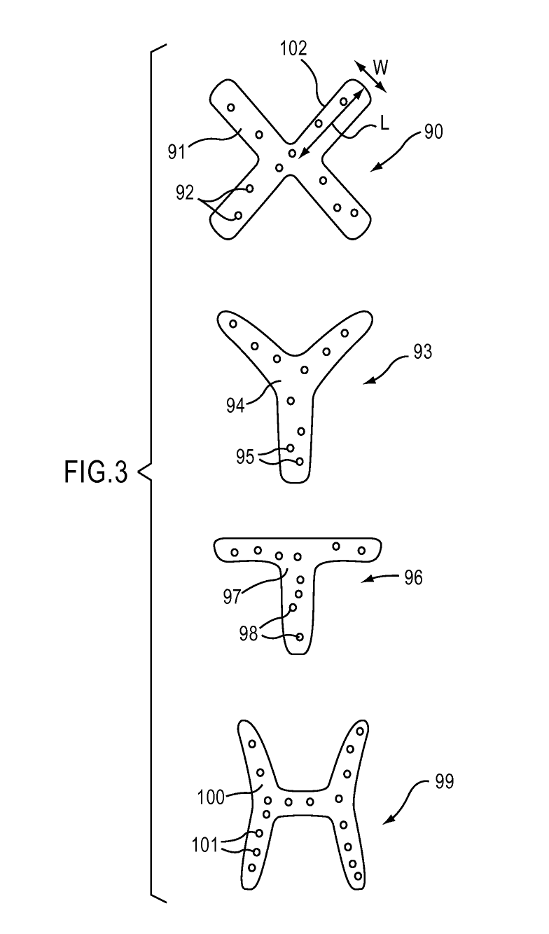

FIG. 3 illustrates cross-sectional views of various cellulosic fibers 90, 93, 96, and 99, according to an embodiment of the invention. As illustrated in FIG. 3, each fiber is a mono-component fiber having a cross-section that is multi-limbed or multi-lobal. Such multi-limbed shape can provide a greater “free” volume within a resulting fabric, which, in turn, can provide a higher level of moisture absorbency. Such multi-limbed shape can also provide a greater surface area for enhanced and quicker moisture absorbency, along with channels for movement and wicking of moisture away from the skin.

As illustrated in FIG. 3, the cellulosic fiber 90 has a cross-section that is generally X-shaped, and includes a cellulosic material 91 and a temperature regulating material 92 dispersed within the cellulosic material 91. The fiber 93 has a cross-section that is generally Y-shaped, and includes a cellulosic material 94 and a temperature regulating material 95 dispersed within the cellulosic material 94. As illustrated in FIG. 3, the fiber 96 has a cross-section that is generally T-shaped, and includes a cellulosic material 97 and a temperature regulating material 98 dispersed within the cellulosic material 97. And, the cellulosic fiber 99 has a cross-section that is generally H-shaped, and includes a cellulosic material 100 and a temperature regulating material 101 dispersed within the cellulosic material 100.

If desired, a length-to-width ratio of limbs included in the fibers 90, 93, 96, and 99 can be adjusted so as to provide a desired balance between mechanical properties and moisture absorbency. For example, in the case of the fiber 90, a ratio of L to W of each limb (e.g., a limb 102) can be from about 1 to about 15, such as from about 2 to about 10, from about 2 to about 7, or from about 3 to about 5.

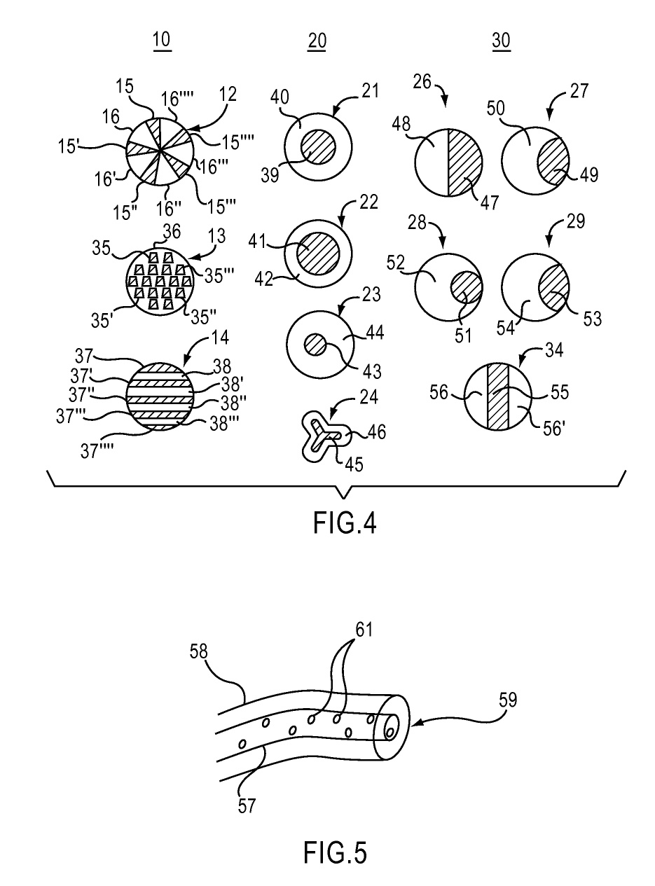

Turning next to FIG. 4, cross-sectional views of various fibers 12, 13, 14, 21, 22, 23, 24, 26, 27, 28, 29, and 34 are illustrated, according to an embodiment of the invention. As illustrated in FIG. 4, each cellulosic fiber is a multi-component fiber that includes various distinct cross-sectional regions. These cross-sectional regions correspond to various elongated members (e.g., elongated members 39 and 40) that form each cellulosic fiber.

In the illustrated embodiment, each cellulosic fiber includes a first set of elongated members (shown shaded in FIG. 4) and a second set of elongated members (shown unshaded in FIG. 4). Here, the first set of elongated members can be formed from a cellulosic material that has a temperature regulating material dispersed therein. The second set of elongated members can be formed from the same material or cellulosic material having somewhat different properties. In general, various elongated members of the first set of elongated members can be formed from the same cellulosic material or different cellulosic materials. Similarly, various elongated members of the second set of elongated members can be formed from the same material or different materials. It is contemplated that one or more elongated members can be formed from various other types of polymeric materials.

For certain applications, a temperature regulating material can be dispersed within a second set of elongated members. Different temperature regulating materials can be dispersed within the same elongated member or different elongated members. For example, a first temperature regulating material can be dispersed within a first set of elongated members, and a second temperature regulating material having somewhat different properties can be dispersed within a second set of elongated members. It is contemplated that one or more elongated members can be formed from a temperature regulating material that need not be dispersed within a cellulosic material or other polymeric material. For example, the temperature regulating material can include a polymeric phase change material that provides enhanced reversible thermal properties and that can be used to form a first set of elongated members. In this case, it may be desirable, but not required, that a second set of elongated members adequately surround the first set of elongated members to reduce or prevent loss or leakage of the temperature regulating material. Various elongated members can be formed from the same polymeric phase change material or different polymeric phase change materials.

Each cellulosic fiber can include various percentages by weight of a first set of elongated members that include a temperature regulating material relative to a second set of elongated members. For example, when thermal regulating properties of a material are a controlling consideration, a larger proportion of the cellulosic fiber can include a first set of elongated members that include a temperature regulating material. On the other hand, when mechanical properties and moisture absorbency of the cellulosic fiber are a controlling consideration, a larger proportion of the cellulosic fiber can include a second set of elongated members that need not include the temperature regulating material. Alternatively, when balancing thermal regulating properties and other properties of the cellulosic fiber, it can be desirable that the second set of elongated members include the same or a different temperature regulating material.

For example, a cellulosic fiber in the illustrated embodiment can include from about 1 percent to about 99 percent by weight of a first set of elongated members. Typically, the cellulosic fiber includes from about 10 percent to about 90 percent by weight of the first set of elongated members. As an example, a cellulosic fiber can include 90 percent by weight of a first elongated member and 10 percent by weight of a second elongated member. For this example, the first elongated member can include 60 percent by weight of a temperature regulating material, such that the cellulosic fiber includes 54 percent by weight of the temperature regulating material. As another example, the cellulosic fiber can include up to about 50 percent by weight of the first elongated member, which in turn can include up to about 50 percent by weight of the temperature regulating material. Such weight percentages provide the cellulosic fiber with up to about 25 percent by weight of the temperature regulating material and provide effective thermal regulating properties, mechanical properties, moisture absorbency, and fire resistance properties for the cellulosic fiber. It is contemplated that a percentage by weight of an elongated member relative to a total weight of a cellulosic fiber can be varied, for example, by adjusting a cross-sectional area of the elongated member or by adjusting the extent to which the elongated member extends through a length of the cellulosic fiber.

Referring to FIG. 4, left-hand column 10 illustrates three fibers 12, 13, and 14. The fiber 12 includes various elongated members arranged in a segmented-pie configuration. In the illustrated embodiment, a first set of elongated members 15, 15′, 15″, 15′″, and 15″″ and a second set of elongated members 16, 16′, 16″, 16′″, and 16″″ are arranged in an alternating fashion and have cross-sections that are wedge-shaped. In general, the elongated members can have cross-sectional shapes and areas that are the same or different. While the fiber 12 is illustrated with ten elongated members, it is contemplated that, in general, two or more elongated members can be arranged in a segmented-pie configuration, and at least one of the elongated members typically will include a temperature regulating.

The cellulosic fiber 13 includes various elongated members arranged in an island-in-sea configuration. In the illustrated embodiment, a first set of elongated members (e.g., elongated members 35, 35′ 35″, and 35′″) are positioned within and surrounded by a second elongated member 36, thereby forming “islands” within a “sea.” Such configuration can serve to provide a more uniform distribution of a temperature regulating material within the cellulosic fiber 13. In the illustrated embodiment, the first set of elongated members have cross-sections that are trapezoidal. In general, the first set of elongated members can have cross-sectional shapes and areas that are the same or different. While the cellulosic fiber 13 is illustrated with seventeen elongated members positioned within and surrounded by the second elongated member 36, it is contemplated that, in general, one or more elongated members can be positioned within and surrounded by the second elongated member 36.

The cellulosic fiber 14 includes various elongated members arranged in a striped configuration. In the illustrated embodiment, a first set of elongated members 37, 37′, 37″, 37″, and 37″″ and a second set of elongated members 38, 38′, 38″, and 38′″ are arranged in an alternating fashion and are shaped as longitudinal slices of the cellulosic fiber 14. In general, the elongated members can have cross-sectional shapes and areas that are the same or different. The cellulosic fiber 14 can be a self-crimping or self-texturing fiber and can impart loft, bulk, insulation, stretch, or other like properties. While the cellulosic fiber 14 is illustrated with nine elongated members, it is contemplated that, in general, two or more elongated members can be arranged in a striped configuration, and at least one of the elongated members typically will include a temperature regulating material.

For the cellulosic fibers 12 and 14, one or more elongated members (e.g., the elongated member 15) of a first set of elongated members can be partially surrounded by one or more adjacent elongated members (e.g., the elongated members 16 and 16″″). When an elongated member including a phase change material is not completely surrounded, it may be desirable, but not required, that a containment structure (e.g., microcapsules) is used to contain the phase change material dispersed within the elongated member. In some instances, the cellulosic fibers 12, 13, and 14 can be further processed to form one or more smaller denier fibers. Thus, for example, the elongated members forming the cellulosic fiber 12 can be split apart, or one or more elongated members (or a portion or portions thereof) can be dissolved, melted, or otherwise removed. A resulting smaller denier fiber can include, for example, the elongated members 15 and 16 coupled to one another.

Middle column 20 of FIG. 4 illustrates four cellulosic fibers 21, 22, 23, and 24. In particular, the cellulosic fibers 21, 22, 23, and 24 each include various elongated members arranged in a core-sheath configuration.

The cellulosic fiber 21 includes a first elongated member 39 positioned within and surrounded by a second elongated member 40. More particularly, the first elongated member 39 is formed as a core member that includes a temperature regulating material. This core member is concentrically positioned within and completely surrounded by the second elongated member 40 that is formed as a sheath member. In the illustrated embodiment, the fiber 21 can include about 25 percent by weight of the core member and about 75 percent by weight of the sheath member.

As discussed for the fiber 21, the cellulosic fiber 22 includes a first elongated member 41 positioned within and surrounded by a second elongated member 42. The first elongated member 41 is formed as a core member that includes a temperature regulating material. This core member is concentrically positioned within and completely surrounded by the second elongated member 42 that is formed as a sheath member. In the illustrated embodiment, the fiber 22 can include about 50 percent by weight of the core member and about 50 percent by weight of the sheath member.

The cellulosic fiber 23 includes a first elongated member 43 positioned within and surrounded by a second elongated member 44. Here, the first elongated member 43 is formed as a core member that is eccentrically positioned within the second elongated member 44 that is formed as a sheath member. The cellulosic fiber 23 can include various percentages by weight of the core member and the sheath member to provide desired thermal regulating properties, mechanical properties, fire resistance and moisture absorbency.

As illustrated in FIG. 4, the cellulosic fiber 24 includes a first elongated member 45 positioned within and surrounded by a second elongated member 46. In the illustrated embodiment, the first elongated member 45 is formed as a core member that has a tri-lobal cross-sectional shape. This core member is concentrically positioned within the second elongated member 46 that is formed as a sheath member. The cellulosic fiber 24 can include various percentages by weight of the core member and the sheath member to provide desired thermal regulating properties, mechanical properties, fire resistance and moisture absorbency.

It is contemplated that, in general, a core member can have any of various regular or irregular cross-sectional shapes, such as, for example, circular, indented, flower petal-shaped, multi-lobal, octagonal, oval, pentagonal, rectangular, serrated, square-shaped, trapezoidal, triangular, wedge-shaped, and so forth. While the cellulosic fibers 21, 22, 23, and 24 are each illustrated with one core member positioned within and surrounded by a sheath member, it is contemplated that two or more core members can be positioned within and surrounded by a sheath member (e.g., in a manner similar to that illustrated for the cellulosic fiber 13). These two or more core members can have cross-sectional shapes and areas that are the same or different. It is also contemplated that a fiber can include three or more elongated members arranged in a core-sheath configuration, such that the elongated members are shaped as concentric or eccentric longitudinal slices of the cellulosic fiber. Thus, for example, the fiber can include a core member positioned within and surrounded by a sheath member, which, in turn, is positioned within and surrounded by another sheath member.

Right-hand column 30 of FIG. 4 illustrates five fibers 26, 27, 28, 29, and 34. In particular, the fibers 26, 27, 28, 29, and 34 each includes various elongated members arranged in a side-by-side configuration.

The fiber 26 includes a first elongated member 47 positioned adjacent to and partially surrounded by a second elongated member 48. In the illustrated embodiment, the elongated members 47 and 48 have half-circular cross-sectional shapes. Here, the cellulosic fiber 26 can include about 50 percent by weight of the first elongated member 47 and about 50 percent by weight of the second elongated member 48. The elongated members 47 and 48 also can be characterized as being arranged in a segmented-pie or a striped configuration.

As discussed for the fiber 26, the cellulosic fiber 27 includes a first elongated member 49 positioned adjacent to and partially surrounded by a second elongated member 50. In the illustrated embodiment, the fiber 27 can include about 20 percent by weight of the first elongated member 49 and about 80 percent by weight of the second elongated member 50. The elongated members 49 and 50 also can be characterized as being arranged in a core-sheath configuration, such that the first elongated member 49 is eccentrically positioned with respect to and partially surrounded by the second elongated member 50.

The cellulosic fibers 28 and 29 are examples of mixed-viscosity fibers. The fibers 28 and 29 each includes a first elongated member 51 or 53 that has a temperature regulating material dispersed therein and is positioned adjacent to and partially surrounded by a second elongated member 52 or 54.

A mixed-viscosity fiber can be considered to be a self-crimping or self-texturing fiber, such that the fiber's crimping or texturing can impart loft, bulk, insulation, stretch, or other like properties. Typically, a mixed-viscosity fiber includes various elongated members that are formed from different polymeric materials. The different polymeric materials used to form the mixed-viscosity fiber can include polymers with different viscosities, chemical structures, or molecular weights. When the mixed-viscosity fiber is drawn, uneven stresses can be created between various elongated members, and the mixed-viscosity fiber can crimp or bend. In some instances, the different polymeric materials used to form the mixed-viscosity fiber can include polymers having different degrees of crystallinity. For example, a first polymeric material used to form a first elongated member can have a lower degree of crystallinity than a second polymeric material used to form a second elongated member. When the mixed-viscosity fiber is drawn, the first and second polymeric materials can undergo different degrees of crystallization to “lock” an orientation and strength into the mixed-viscosity fiber. A sufficient degree of crystallization can be desired to prevent or reduce reorientation of the mixed-viscosity fiber during subsequent processing (e.g., heat treatment).

For example, for the cellulosic fiber 28, the first elongated member 51 can be formed from a first cellulosic material, and the second elongated member 52 can be formed from a second cellulosic material having somewhat different properties. It is contemplated that the first elongated member 51 and the second elongated member 52 can be formed from the same cellulosic material, and a temperature regulating material can be dispersed within the first elongated member 51 to impart self-crimping or self-texturing properties to the cellulosic fiber 28. It is also contemplated that the first elongated member 51 can be formed from a polymeric phase change material, and the second elongated member 52 can be formed from a material having somewhat different properties. The fibers 28 and 29 can include various percentages by weight of the first elongated members 51 and 53 and the second elongated members 52 and 54 to provide desired thermal regulating properties, mechanical properties, moisture absorbency, fire resistance and self-crimping or self-texturing properties.

The cellulosic fiber 34 is an example of an ABA fiber. As illustrated in FIG. 4, the fiber 34 includes a first elongated member 55 positioned between and partially surrounded by a second set of elongated members 56 and 56′. In the illustrated embodiment, the first elongated member 55 is formed from a material that has a temperature regulating material dispersed therein. Here, the second set of elongated members 56 and 56′ can be formed from the same material or another material having somewhat different properties. In general, the elongated members 55, 56, and 56′ can have cross-sectional shapes and areas that are the same or different. The elongated members 55, 56, and 56′ also can be characterized as being arranged in a striped configuration.

Attention next turns to FIG. 5, which illustrates a three-dimensional view of a cellulosic fiber 59 having a core-sheath configuration, according to an embodiment of the invention. The fiber 59 includes an elongated and generally cylindrical core member 57 positioned within and surrounded by an elongated and annular-shaped sheath member 58. In the illustrated embodiment, the core member 57 substantially extends through a length of the cellulosic fiber 59 and is completely surrounded or encased by the sheath member 58, which forms an exterior of the cellulosic fiber 59. In general, the core member 57 can be concentrically or eccentrically positioned within the sheath member 58.

As illustrated in FIG. 5, the core member 57 includes a temperature regulating material 61 dispersed therein. In the illustrated embodiment, the temperature regulating material 61 can include various microcapsules containing a phase change material, and the microcapsules can be substantially uniformly dispersed throughout the core member 57. While it may be desirable to have the microcapsules uniformly dispersed within the core member 57, such configuration is not necessary in all applications. The core member 57 and the sheath member 58 can be formed from the same material or different cellulosic materials. It is contemplated that either, or both, of the core member 57 and the sheath member 58 can be formed from various other types of polymeric materials. The cellulosic fiber 59 can include various percentages by weight of the core member 57 and the sheath member 58 to provide desired thermal regulating properties, mechanical properties, fire resistance and moisture absorbency.

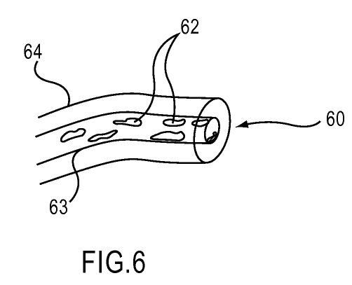

FIG. 6 illustrates a three-dimensional view of another cellulosic fiber 60 having a core-sheath configuration, according to an embodiment of the invention. As discussed for the fiber 59, the fiber 60 includes an elongated and generally cylindrical core member 63 substantially extending through a length of the fiber 60. The core member 63 is positioned within and completely surrounded or encased by an elongated and annular-shaped sheath member 64, which forms an exterior of the fiber 60. In general, the core member 63 can be concentrically or eccentrically positioned within the sheath member 64.

As illustrated in FIG. 6, the core member 63 includes a temperature regulating material 62 dispersed therein. Here, the temperature regulating material 62 can include a phase change material in a raw form, and the phase change material can be substantially uniformly dispersed throughout the core member 63. While it may be desirable to have the phase change material uniformly dispersed within the core member 63, such configuration is not necessary in all applications. In the illustrated embodiment, the phase change material can form distinct domains that are dispersed within the core member 63. By surrounding the core member 63, the sheath member 64 can serve to enclose the phase change material within the core member 63. Accordingly, the sheath member 64 can reduce or prevent loss or leakage of the phase change material during fiber formation or during end use. The core member 63 and the sheath member 64 can be formed from the same material or different materials. It is contemplated that either, or both, of the core member 63 and the sheath member 64 can be formed from various other types of polymeric materials. Thus, for example, it is contemplated that the core member 63 can be formed from a polymeric phase change material that need not be dispersed in a cellulosic material. The fiber 60 can include various percentages by weight of the core member 63 and the sheath member 64 to provide desired thermal regulating properties, mechanical properties, fire resistance and moisture absorbency.

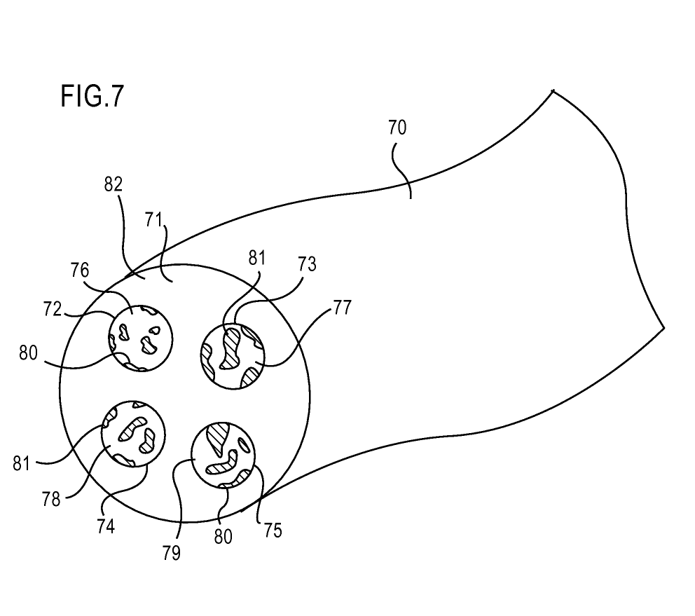

Referring to FIG. 7, a three-dimensional view of a cellulosic fiber 70 having an island-in-sea configuration is illustrated, according to an embodiment of the invention. The fiber 70 includes a set of elongated and generally cylindrical island members 72, 73, 74, and 75 positioned within and surrounded by an elongated sea member 71. In the illustrated embodiment, the island members 72, 73, 74, and 75 substantially extend through a length of the cellulosic fiber 70 and are completely surrounded or encased by the sea member 71, which forms an exterior of the fiber 70. While four island members are illustrated, it is contemplated that the fiber 70 can include more or less islands members depending upon the particular application of the fiber 70.

One or more temperature regulating materials can be dispersed within the island members 72, 73, 74, and 75. As illustrated in FIG. 7, the fiber 70 includes two different temperature regulating materials 80 and 81. The island members 72 and 75 include the temperature regulating material 80, while the island members 73 and 74 include the temperature regulating material 81. In the illustrated embodiment, the temperature regulating materials 80 and 81 can include different phase change materials in a raw form, and the phase change materials can form distinct domains that are dispersed within respective island members. By surrounding the island members 72, 73, 74, and 75, the sea member 71 can serve to enclose the phase change materials within the island members 72, 73, 74, and 75.

In the illustrated embodiment, the sea member 71 is formed of a sea cellulosic/modacrylic material 82, and the island members 72, 73, 74, and 75 are formed of island cellulosic/modacrylic materials 76, 77, 78, and 79, respectively. The sea material 82 and the island materials 76, 77, 78, and 79 can be the same or can differ from one another in some fashion. It is contemplated that one or more of the sea member 71 and the island members 72, 73, 74, and 75 can be formed from various other types of polymeric materials. Thus, for example, it is contemplated that one or more of the island members 72, 73, 74, and 75 can be formed from a polymeric phase change material that need not be dispersed in a cellulosic/modacrylic material. The fiber 70 can include various percentages by weight of the sea member 71 and the island members 72, 73, 74, and 75 to provide desired thermal regulating properties, mechanical properties, fire resistance and moisture absorbency.

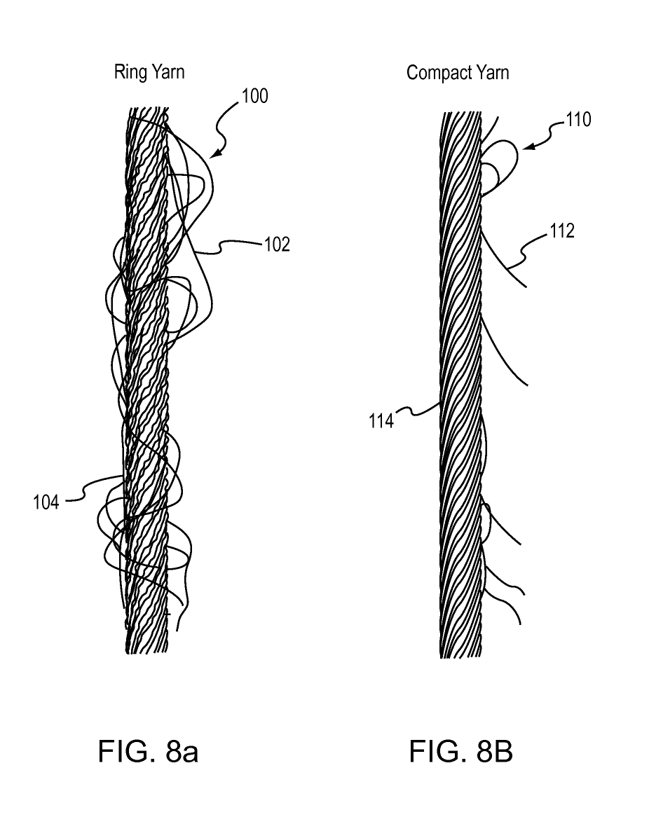

FIGS. 8A and 8B illustrate several yarn structures that may embody aspects of the present invention where one or more of the yarn fibers is formed from a cellulosic material as described herein and one or more of the yarn fibers is formed from a fire resistant material as described herein. In general yarn is a long continuous length of interlocked fibers suitable for use in the production of textiles and other fabrics and articles. As one example, spun yarn is made by twisting or otherwise bonding staple fibers together to make a cohesive thread. Spun yarns may contain a single type of fiber, or be a blend of various types. Aspects of the present invention relate to combining synthetic fibers with fire retardant qualities with cellulosic fibers that have temperature regulating properties. Yarns may also be made up of a number of plies, each ply being a single spun yarn. These single plies of yarn are twisted together (plied) in the opposite direction to make a thicker yarn. FIGS. 8A (Ring yarn) and 8B (Compact Yarn) show several examples of these yarn structures that may be used in conjunction with aspects of the present invention. Ring yarn 100 may include a first plurality of cellulosic temperature regulating fibers 102 and a second plurality of fire resistant fibers 104. Similarly compact yarn 110 may include a first plurality of cellulosic temperature regulating fibers 112 and a second plurality of fire resistant fibers 114.

Each of the above examples are contemplated to embody a fiber, yarn or fabric that includes a blend of cellulosic fibers and fire resistant fibers such as a modacrylic fiber described herein. The above examples are used only as structural embodiments to described the combined fire resistance and temperature regulation features of the present invention.

### Cellulosic Materials

An important class of regenerated fibers includes fibers formed from cellulose. Cellulose is a significant component of plant matter, such as, for example, leaves, wood, bark, and cotton. Conventionally, a solution spinning process is used to form fibers from cellulose. A wet solution spinning process is conventionally used to form rayon fibers and lyocell fibers, while a dry solution spinning process is conventionally used to form acetate fibers. Rayon fibers and lyocell fibers often include cellulose having the same or similar chemical structure as naturally occurring cellulose. However, cellulose included in these fibers often has a shorter molecular chain length relative to naturally occurring cellulose. For example, rayon fibers often include cellulose in which substituents have replaced not more than about 15 percent of hydrogens of hydroxyl groups in the cellulose. Examples of rayon fibers include viscose rayon fibers and cuprammonium rayon fibers. Acetate fibers often include a chemically modified form of cellulose in which various hydroxyl groups are replaced by acetyl groups.

Fibers formed from cellulose find numerous applications. For example, these fibers can be used to form knitted or woven fabrics, which can be incorporated in products such as apparel or footwear. Fabrics formed from these fibers are generally perceived as comfort fabrics due to their ability to take up moisture and their low retention of body heat. These properties make the fabrics desirable in warm weather by allowing a wearer to feel cooler. However, these same properties can make the fabrics undesirable in cold weather. In cold and damp weather, the fabrics can be particularly undesirable due to rapid removal of body heat when the fabrics are wet. As another example, fibers formed from cellulose can be used to form non-woven fabrics, which can be incorporated in products such as personal hygiene products or medical products. Non-woven fabrics formed from these fibers are generally perceived as desirable due to their ability to take up moisture. However, for similar reasons as discussed above, the non-woven fabrics generally fail to provide a desirable level of comfort, particularly under changing environmental conditions.

Cellulosic fibers in accordance with various embodiments of the invention can provide an improved level of comfort when incorporated in products such as, for example, apparel, footwear, personal hygiene products, and medical products. In particular, the cellulosic fibers can provide such improved level of comfort under different environmental conditions. The use of phase change materials allows the cellulosic fibers to exhibit “dynamic” heat retention rather than “static” heat retention. Heat retention typically refers to the ability of a material to retain heat (e.g., body heat). A low level of heat retention is often desired in warm weather, while a high level of heat retention is often desired in cold weather. Unlike conventional fibers formed from cellulose, cellulosic fibers in accordance with various embodiments of the invention can exhibit different levels of heat retention under changing environmental conditions. For example, the cellulosic fibers can exhibit a low level of heat retention in warm weather and a high level of heat retention in cold weather, thus maintaining a desired level of comfort under changing weather conditions.

In conjunction with exhibiting “dynamic” heat retention, cellulosic fibers in accordance with various embodiments of the invention can exhibit a high level of moisture absorbency. Moisture absorbency typically refers to the ability of a material to absorb or take up moisture. In some instances, moisture absorbency of a material can be expressed as a percentage weight gain resulting from absorbed moisture relative to a moisture-free weight of the material under a particular environmental condition (e.g., 21° C. and 65 percent relative humidity). Cellulosic fibers in accordance with various embodiments of the invention can exhibit moisture absorbency of at least 5 percent, such as from about 6 percent to about 15 percent, from about 6 percent to about 13 percent, or from about 11 percent to about 13 percent. A high level of moisture absorbency can serve to reduce the amount of skin moisture, such as due to perspiration. In the case of personal hygiene products, this high level of moisture absorbency can also serve to draw moisture away from the skin and to trap the moisture, thereby reducing or preventing skin irritation or rashes. In addition, moisture absorbed by cellulosic fibers can enhance the heat conductivity of the cellulosic fibers. Thus, for example, when incorporated in apparel or footwear, the cellulosic fibers can serve to reduce the amount of skin moisture as well as lower skin temperature, thereby providing a higher level of comfort in warm weather. The use of phase change materials in the cellulosic fibers further enhances the level of comfort by absorbing or releasing thermal energy to maintain a comfortable skin temperature.

In addition, cellulosic fibers in accordance with various embodiments of the invention can exhibit other desirable properties. For example, when incorporated in non-woven fabrics, the cellulosic fibers can have one or more of the following properties: (1) a sink time that is from about 2 seconds to about 60 seconds, such as from about 3 seconds to about 20 seconds or from about 4 seconds to about 10 seconds; (2) a tensile strength that is from about 13 cN/tex to about 40 cN/tex, such as from about 16 cN/tex to about 30 cN/tex or from about 18 cN/tex to about 25 cN/tex; (3) an elongation at break that is from about 10 percent to about 40 percent, such as from about 14 percent to about 30 percent or from about 17 percent to about 22 percent; and (4) a shrinkage in boiling water that is from about 0 percent to about 6 percent, such as from about 0 percent to about 4 percent or from about 0 percent to about 3 percent.

A cellulosic fiber according to some embodiments of the invention can include a set of elongated members. As used herein, the term “set” refers to a collection of one or more objects. In some instances, the cellulosic fiber can include a fiber body formed of the set of elongated members. The fiber body is typically elongated and can have a length that is several times (e.g., 100 times or more) greater than its diameter. In some instances, a staple length of the fiber body can be from about 0.3 mm to about 100 mm, such as from about 4 mm to about 75 mm or from about 20 mm to about 50 mm. The fiber body can have any of various regular or irregular cross-sectional shapes, such as circular, C-shaped, indented, flower petal-shaped, multi-limbed or multi-lobal, octagonal, oval, pentagonal, rectangular, ring-shaped, serrated, square-shaped, star-shaped, trapezoidal, triangular, wedge-shaped, and so forth. Various elongated members of the set of elongated members can be coupled (e.g., bonded, combined, joined, or united) to one another to form a unitary fiber body.

Wicking properties can be incorporated by either specific synthetic wicking fiber shapes (e.g. Coolmax), permanent wicking additives incorporated into synthetic fibers when they are manufactured (e.g. Cocona® carbon particles), PCM microcapsules (when they are added to acrylic or viscose fiber they increase the porosity of the fiber structure which leads to increased wicking), addition or blends of natural fibers that wick such as cotton, wool, viscose, etc., specific yarn constructions that aid wicking (Dri-release®), and/or additional topical treatments which can be added separately or as part of the PCM coating process.

Each of the above examples are contemplated to embody a yarn or fabric that includes a blend of cellulosic fibers and fire resistant fibers such as a modacrylic fiber described herein. The above examples are used only as examples of cellulosic materials incorporated into various embodiments of the present invention.

In addition, it is contemplated that each of the above fiber examples may be incorporated into an end product such as a fabric, yarn, garment, article, coating or construction material.

### Phase Change Materials

In general, a phase change material used in connection with each of the examples described herein may comprise any substance (or mixture of substances) that has the capability of absorbing or releasing thermal energy to reduce or eliminate heat flow at or within a temperature stabilizing range. The temperature stabilizing range of a particular phase change material may comprise a particular transition temperature or range of transition temperatures as described herein. A phase change material used in conjunction with various embodiments of the invention is capable of inhibiting a flow of thermal energy during a time when the phase change material is absorbing or releasing heat, typically as the phase change material undergoes a transition between two states (e.g., liquid and solid states, liquid and gaseous states, solid and gaseous states, or two solid states). This action is typically transient, e.g., will occur until a latent heat of the phase change material is absorbed or released during a heating or cooling process. Thermal energy may be stored or removed from the phase change material, and the phase change material typically can be effectively recharged by a source of heat or cold. By selecting an appropriate phase change material, the coated article or fiber may be designed for use in any one of numerous products.

As used herein, the term “latent heat” refers to an amount of heat absorbed or released by a material as it undergoes a transition between two states. Thus, for example, a latent heat can refer to an amount of heat that is absorbed or released as a material undergoes a transition between a liquid state and a crystalline solid state, a liquid state and a gaseous state, a crystalline solid state and a gaseous state, two crystalline solid states or crystalline state and amorphous state.

As used herein, the term “transition temperature” refers to an approximate temperature at which a material undergoes a transition between two states. Thus, for example, a transition temperature can refer to a temperature at which a material undergoes a transition between a liquid state and a crystalline solid state, a liquid state and a gaseous state, a crystalline solid state and a gaseous state, two crystalline solid states or crystalline state and amorphous state . . . . A temperature at which an amorphous material undergoes a transition between a glassy state and a rubbery state may also be referred to as a “glass transition temperature” of the material.

A phase change material used in connection with each of the examples described herein may be a solid/solid phase change material. A solid/solid phase change material is a type of phase change material that typically undergoes a transition between two solid states (e.g., a crystalline or mesocrystalline phase transformation) and hence typically does not become a liquid during use.

Phase change materials that can be incorporated in the articles and fibers described herein include a variety of organic and inorganic substances. Exemplary phase change materials include, by way of example and not by limitation, hydrocarbons (e.g., straight chain alkanes or paraffinic hydrocarbons, branched-chain alkanes, unsaturated hydrocarbons, halogenated hydrocarbons, and alicyclic hydrocarbons), hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids, fatty acid esters, dibasic acids, dibasic esters, 1-halides, primary alcohols, aromatic compounds, clathrates, semi-clathrates, gas clathrates, anhydrides (e.g., stearic anhydride), ethylene carbonate, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers comprising polyethylene, polyethylene glycol, polyethylene oxide, polypropylene, polypropylene glycol, or polytetramethylene glycol), metals, and mixtures thereof.

Particularly useful phase change materials include paraffinic hydrocarbons having between 10 to 44 carbon atoms (i.e., C₁₀-C₄₄ paraffinic hydrocarbons). Table 1 provides a list of exemplary C₁₃-C₂₈ paraffinic hydrocarbons that may be used as the phase change material in the coated articles described herein. The number of carbon atoms of a paraffinic hydrocarbon typically correlates with its melting point. For example, n-Octacosane, which contains twenty-eight straight chain carbon atoms per molecule, has a melting point of 61.4° C. By comparison, n-Tridecane, which contains thirteen straight chain carbon atoms per molecule, has a melting point of −5.5° C.

TABLE 1

| | No. of | Melting |
|---|---|---|
| Paraffinic | Carbon | Point |
| Hydrocarbon | Atoms | (° C.) |
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

Other useful phase change materials include polymeric phase change materials having transition temperatures suitable for a desired application of the coated article (e.g., from about 22° C. to about 40° C. for clothing applications). Other ranges of transition temperatures are also envisioned, such as from about 0° C. to about 40° C.

A polymeric phase change material may comprise a polymer (or mixture of polymers) having a variety of chain structures that include one or more types of monomer units. In particular, polymeric phase change materials may include linear polymers, branched polymers (e.g., star branched polymers, comb branched polymers, or dendritic branched polymers), or mixtures thereof. A polymeric phase change material may comprise a homopolymer, a copolymer (e.g., terpolymer, statistical copolymer, random copolymer, alternating copolymer, periodic copolymer, block copolymer, radial copolymer, or graft copolymer), or a mixture thereof. As one of ordinary skill in the art will understand, the reactivity and functionality of a polymer may be altered by addition of a functional group such as, for example, amine, amide, carboxyl, hydroxyl, ester, ether, epoxide, anhydride, isocyanate, silane, ketone, aldehyde, or unsaturated group. Also, a polymer comprising a polymeric phase change material may be capable of crosslinking, entanglement, or hydrogen bonding in order to increase its toughness or its resistance to heat, moisture, or chemicals.

According to some embodiments of the invention, a polymeric phase change material may be desirable as a result of having a higher molecular weight, larger molecular size, or higher viscosity relative to non-polymeric phase change materials (e.g., paraffinic hydrocarbons). As a result of this larger molecular size or higher viscosity, a polymeric phase change material may exhibit a lesser tendency to leak from the coating during processing or during end use. In addition to providing thermal regulating properties, a polymeric phase change material may provide improved mechanical properties (e.g., ductility, tensile strength, and hardness) when incorporated in the coating. According to some embodiments of the invention, the polymeric phase change material may be used to form the coating without requiring the polymeric material, thus allowing for a higher loading level of the polymeric phase change material and improved thermal regulating properties. Since the polymeric material is not required, use of the polymeric phase change material may allow for a thinner coating and improved flexibility, softness, air permeability, or water vapor transport properties for the coated article.

For example, polyethylene glycols may be used as the phase change material in some embodiments of the invention. The number average molecular weight of a polyethylene glycol typically correlates with its melting point. For instance, a polyethylene glycol having a number average molecular weight range of 570 to 630 (e.g., Carbowax 600) will have a melting point of 20° to 25° C., making it desirable for clothing applications. Other polyethylene glycols that may be useful at other temperature stabilizing ranges include Carbowax 400 (melting point of 4° to 8° C.), Carbowax 1500 (melting point of 44° to 48° C.), and Carbowax 6000 (melting point of 56° to 63° C.). Polyethylene oxides having a melting point in the range of 60° to 65° C. may also be used as phase change materials in some embodiments of the invention. Further desirable phase change materials include polyesters having a melting point in the range of 0° to 40° C. that may be formed, for example, by polycondensation of glycols (or their derivatives) with diacids (or their derivatives). Table 2 sets forth melting points of exemplary polyesters that may be formed with various combinations of glycols and diacids.

TABLE 2

| | | Melting Point |
|---|---|---|
| | | of Polyester |
| Glycol | Diacid | (° C.) |
| Ethylene glycol | Carbonic | 39 |
| Ethylene glycol | Pimelic | 25 |
| Ethylene glycol | Diglycolic | 17-20 |
| Ethylene glycol | Thiodivaleric | 25-28 |
| 1,2-Propylene glycol | Diglycolic | 17 |
| Propylene glycol | Malonic | 33 |
| Propylene glycol | Glutaric | 35-39 |
| Propylene glycol | Diglycolic | 29-32 |
| Propylene glycol | Pimelic | 37 |
| 1,3-butanediol | Sulphenyl divaleric | 32 |
| 1,3-butanediol | Diphenic | 36 |
| 1,3-butanediol | Diphenyl methane-m,m′-diacid | 38 |
| 1,3-butanediol | trans-H,H-terephthalic acid | 18 |
| Butanediol | Glutaric | 36-38 |
| Butanediol | Pimelic | 38-41 |
| Butanediol | Azelaic | 37-39 |
| Butanediol | Thiodivaleric | 37 |
| Butanediol | Phthalic | 17 |
| Butanediol | Diphenic | 34 |
| Neopentyl glycol | Adipic | 37 |
| Neopentyl glycol | Suberic | 17 |
| Neopentyl glycol | Sebacic | 26 |
| Pentanediol | Succinic | 32 |
| Pentanediol | Glutaric | 22 |
| Pentanediol | Adipic | 36 |
| Pentanediol | Pimelic | 39 |
| Pentanediol | para-phenyl diacetic acid | 33 |
| Pentanediol | Diglycolic | 33 |
| Hexanediol | Glutaric | 28-34 |
| Hexanediol | 4-Octenedioate | 20 |
| Heptanediol | Oxalic | 31 |
| Octanediol | 4-Octenedioate | 39 |
| Nonanediol | meta-phenylene diglycolic | 35 |
| Decanediol | Malonic | 29-34 |
| Decanediol | Isophthalic | 34-36 |
| Decanediol | meso-tartaric | 33 |
| Diethylene glycol | Oxalic | 10 |
| Diethylene glycol | Suberic | 28-35 |
| Diethylene glycol | Sebacic | 36-44 |
| Diethylene glycol | Phthalic | 11 |
| Diethylene glycol | trans-H,H-terephthalic acid | 25 |
| Triethylene glycol | Sebacic | 28 |
| Triethylene glycol | Sulphonyl divaleric | 24 |
| Triethylene glycol | Phthalic | 10 |
| Triethylene glycol | Diphenic | 38 |
| para-dihydroxy- | Malonic | 36 |
| methylbenzene | | |
| meta-dihydroxy- | Sebacic | 27 |
| methylbenzene | | |
| meta-dihydroxy- | Diglycolic | 35 |
| methylbenzene | | |

A polymeric phase change material having a desired transition temperature may also be formed by reacting a phase change material (e.g., an exemplary phase change material discussed above) with a polymer (or mixture of polymers). Thus, for example, n-octadecylic acid (i.e., stearic acid) may be reacted or esterified with polyvinyl alcohol to yield polyvinyl stearate, or dodecanoic acid (i.e., lauric acid) may be reacted or esterified with polyvinyl alcohol to yield polyvinyl laurate. Various combinations of the different phase change materials described above and in the included tables (e.g., phase change materials with one or more functional groups such as amine, carboxyl, hydroxyl, epoxy, silane, sulfuric, and so forth) and polymers may be reacted to yield polymeric phase change materials having desired transition temperatures.

The selection of a phase change material can also be dependent upon a latent heat of the phase change material. A latent heat of a phase change material typically correlates with its ability to regulate heat transfer. In some instances, a phase change material can have a latent heat that is at least about 1 Joule per gram, at least about 5 Joules per gram (J/g), at least about 10 J/g, at least about 20 J/g, at least about 30 J/g, at least about 40 J/g, at least about 50 J/g, at least about 60 J/g, at least about 70 J/g, at least about 80 J/g, at least about 90 J/g, or at least about 100 J/g. Thus, for example, the phase change material can have a latent heat from about 5 J/g to about 400 J/g, 10 J/g to about 100, J/g, 20 J/g to about 100 J/g, from about 60 J/g to about 400 J/g, from about 80 J/g to about 400 J/g, or from about 100 J/g to about 400 J/g.

A polymeric phase change material used in connection with the embodiments described herein may also include functionally reactive aspects such as those described in U.S. Patent Application Publication Nos. 2010/0016513, 2010/0012883, and 2010/0264353, the details of which are incorporated by reference into the present application by reference. For example, the reactive function can be of various chemical natures. For example, reactive functions capable of reacting and forming electrovalent bonds or covalent bonds with reactive functions of various substrates, e.g. cotton, wool, fur, leather, polyester and textiles made from such materials, as well as other base materials. For example, materials made from natural, regenerated or synthetic polymers/fibers/materials may form a covalent or electrovalent bond. Further examples of such substrates include various types of natural products including animal products such as alpaca, angora, camel hair, cashmere, catgut, chiengora, llama, mohair, silk, sinew, spider silk, wool, and protein based materials, various types of vegetable based products such as bamboo, coir, cotton, flax, hemp, jute, kenaf, manila, piña, raffia, ramie, sisal, and cellulose based materials; various types of mineral based products such as asbestos, basalt, mica, or other natural inorganic fibers. As used here, the term “reactive function” means a chemical group (or a moiety) capable of reacting with another chemical group to form a covalent or an electrovalent bond,

A phase change material can comprise a mixture of two or more substances (e.g., two or more of the exemplary phase change materials discussed above). By selecting two or more different substances (e.g. two different paraffinic hydrocarbons or a hydrocarbon and a glycol) and forming a mixture thereof, a temperature stabilizing range can be adjusted over a wide range for any particular application of the coated article. According to some embodiments of invention, the mixture of two or more different substances may exhibit two or more distinct transition temperatures or a single modified transition temperature.

### PCM Containment Structures

A temperature regulating material described herein may comprise a containment structure that encapsulates, contains, surrounds, absorbs, affects the viscosity/rheology or otherwise reacts with the phase change material. This containment structure may facilitate handling of the phase change material while offering a degree of protection to the phase change material during manufacture of the fiber, fabric, yarn or end-product made therefrom. Moreover, the containment structure may serve to reduce or prevent leakage of the phase change material from the fiber, fabric, yarn or end-product during end use.

According to some embodiments of the invention, use of a containment structure can be desirable, but not required, when an elongated member having a phase change material dispersed therein is not completely surrounded by another elongated member. Furthermore, it has been discovered that use of a containment structure along with a phase change material can provide various other benefits, such as: (1) providing comparable or superior properties (e.g., in terms of moisture absorbency) relative to a standard cellulosic fiber; (2) allowing for a lower density cellulosic fiber so as to provide a resulting product at lower overall weight; and (3) serving as a less expensive dulling agent that can be used in place of, or in conjunction with, a standard dulling agent (e.g., TiO₂). Without wishing to be bound by a particular theory, it is believed that certain of these benefits result from the relatively low density of certain containment structures as well as the formation of voids within a resulting cellulosic fiber.

For example, a temperature regulating material can include various microcapsules that contain a phase change material, and the microcapsules can be uniformly, or non-uniformly, dispersed within one or more elongated members forming a cellulosic fiber. Microcapsules can be formed as shells enclosing a phase change material, and can include individual microcapsules formed in various regular or irregular shapes (e.g., spherical, spheroidal, ellipsoidal, and so forth) and sizes. The microcapsules can have the same shape or different shapes, and can have the same size or different sizes. As used herein, the term “size” refers to a largest dimension of an object. Thus, for example, a size of a spheroid can refer to a major axis of the spheroid, while a size of a sphere can refer to a diameter of the sphere. In some instances, the microcapsules can be substantially spheroidal or spherical, and can have sizes ranging from about 0.01 to about 4,000 microns, such as from about 0.1 to about 1,000 microns, from about 0.1 to about 500 microns, from about 0.1 to about 100 microns, from about 0.1 to about 20 microns, from about 0.3 to about 5 microns, or from about 0.5 to about 3 microns. For certain implementations, it can be desirable that a substantial fraction, such as at least about 50 percent, at least about 60 percent, at least about 70 percent, at least about 80 percent, or up to about 100 percent, of the microcapsules have sizes within a specified range, such as less than about 12 microns, from about 0.1 to about 12 microns, or from about 0.1 to about 10 microns. It can also be desirable that the microcapsules are monodisperse with respect to either of, or both, their shapes and sizes. As used herein, the term “monodisperse” refers to being substantially uniform with respect to a set of properties. Thus, for example, a set of microcapsules that are monodisperse can refer to such microcapsules that have a narrow distribution of sizes around a mode of the distribution of sizes, such as a mean of the distribution of sizes. In some instances, a set of microcapsules that are monodisperse can have sizes exhibiting a standard deviation of less than 20 percent with respect to a mean of the sizes, such as less than 10 percent or less than 5 percent. Examples of techniques to form microcapsules can be found in the following references: Tsuei et al., U.S. Pat. No. 5,589,194, entitled “Method of Encapsulation and Microcapsules Produced Thereby;” Tsuei, et al., U.S. Pat. No. 5,433,953, entitled “Microcapsules and Methods for Making Same;” Hatfield, U.S. Pat. No. 4,708,812, entitled “Encapsulation of Phase Change Materials;” and Chen et al., U.S. Pat. No. 4,505,953, entitled “Method for Preparing Encapsulated Phase Change Materials;” the disclosures of which are herein incorporated by reference in their entireties.

Other examples of containment structures include silica particles (e.g., precipitated silica particles, fumed silica particles, and mixtures thereof), zeolite particles, carbon particles (e.g., graphite particles, activated carbon particles, and mixtures thereof), and absorbent materials (e.g., absorbent polymeric materials such as certain cellulosic materials, superabsorbent materials, poly(meth)acrylate materials, metal salts of poly(meth)acrylate materials, and mixtures thereof). For example, a temperature regulating material can include silica particles, zeolite particles, carbon particles, or an absorbent material impregnated with a phase change material. According to other embodiments of the invention, the temperature regulating material may comprise a phase change material in a raw form (e.g., the phase change material is non-encapsulated, i.e., not micro- or macroencapsulated). During manufacture of the article, the phase change material in the raw form may be provided as a solid in a variety of forms (e.g., bulk form, powders, pellets, granules, flakes, and so forth) or as a liquid in a variety of forms (e.g., molten form, dissolved in a solvent, and so forth). To reduce or prevent leakage of the phase change material, it may be desirable, but not required, that a phase change material used in a raw form is a solid/solid or polymeric phase change material.

### Polymeric Materials

In general, a polymeric material used herein may comprise any polymer (or mixture of polymers) that has the capability of being formed into a coating. According to some embodiments of the invention, the polymeric material may provide a matrix within which the temperature regulating material may be dispersed and may serve to bind the temperature regulating material to the substrate. The polymeric material may offer a degree of protection to the temperature regulating material during manufacture of the coated article or a product made therefrom or during end use. According to some embodiments of the invention, the polymeric material may comprise a thermoplastic polymer (or mixture of thermoplastic polymers) or a thermoset polymer (or mixture of thermoset polymers).

The polymeric material may comprise a polymer (or mixture of polymers) having a variety of chain structures that include one or more types of monomer units. In particular, the polymeric material may comprise a linear polymer, a branched polymer (e.g., star branched polymer, comb branched polymer, or dendritic branched polymer), or a mixture thereof. The polymeric material may comprise a homopolymer, a copolymer (e.g., terpolymer, statistical copolymer, random copolymer, alternating copolymer, periodic copolymer, block copolymer, radial copolymer, or graft copolymer), or a mixture thereof. As discussed previously, the reactivity and functionality of a polymer may be altered by addition of a functional group such as, for example, amine, amide, carboxyl, hydroxyl, ester, ether, epoxide, anhydride, isocyanate, silane, ketone, aldehyde, or unsaturated group. Also, a polymer comprising the polymeric material may be capable of crosslinking, entanglement, or hydrogen bonding in order to increase its toughness or its resistance to heat, moisture, or chemicals.

Exemplary polymeric materials that may be used to form the coating include, by way of example and not by limitation, polyamides, polyamines, polyimides, polyacrylics (e.g., polyacrylamide, polyacrylonitrile, esters of methacrylic acid and acrylic acid, and so forth), polycarbonates (e.g., polybisphenol A carbonate, polypropylene carbonate, and so forth), polydienes (e.g., polybutadiene, polyisoprene, polynorbornene, and so forth), polyepoxides, polyesters (e.g., polycaprolactone, polyethylene adipate, polybutylene adipate, polypropylene succinate, polyesters based on terephthalic acid, polyesters based on phthalic acid, and so forth), polyethers (e.g., polyethylene glycol (polyethylene oxide), polybutylene glycol, polypropylene oxide, polyoxymethylene (paraformaldehyde), polytetramethylene ether (polytetrahydrofuran), polyepichlorohydrin, and so forth), polyfluorocarbons, formaldehyde polymers (e.g., urea-formaldehyde, melamine-formaldehyde, phenol formaldehyde, and so forth), natural polymers (e.g., cellulosics, chitosans, lignins, waxes, and so forth), polyolefins (e.g., polyethylene, polypropylene, polybutylene, polybutene, polyoctene, and so forth), polyphenylenes, silicon containing polymers (e.g., polydimethyl siloxane, polycarbomethyl silane, and so forth), polyurethanes, polyvinyls (e.g., polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone, and so forth), polyacetals, polyarylates, alkyd based polymers (i.e., polymers based on glyceride oil), and copolymers (e.g., polyethylene-co-vinyl acetate, polyethylene-co-acrylic acid, and so forth).

For certain applications of the coated article, the polymeric material may comprise a polymer (or mixture of polymers) that facilitates dispersing or incorporating the temperature regulating material within the coating. For instance, the polymeric material may comprise a polymer (or mixture of polymers) that is compatible or miscible with or has an affinity for the temperature regulating material. In some embodiments of the invention, this affinity may depend on, by way of example and not by limitation, similarity of solubility parameters, polarities, hydrophobic characteristics, or hydrophilic characteristics of the polymeric material and the temperature regulating material. Such affinity may facilitate incorporation of a more uniform or higher loading level of the temperature regulating material in the coating. In addition, a smaller amount of the polymeric material may be needed to incorporate a desired loading level of the temperature regulating material, thus allowing for a thinner coating and improved flexibility, softness, air permeability, or water vapor transport properties for the coated article. In embodiments where the temperature regulating material comprises a containment structure that contains a phase change material, the polymeric material may comprise a polymer (or mixture of polymers) selected for its affinity for the containment structure in conjunction with or as an alternative to its affinity for the phase change material. For instance, if the temperature regulating material comprises a plurality of microcapsules containing the phase change material, a polymer (or mixture of polymers) may be selected having an affinity for the microcapsules (e.g., for a material or materials of which the microcapsules are formed). For instance, some embodiments of the invention may select the polymeric material to comprise the same or a similar polymer as a polymer comprising the microcapsules. In some presently preferred embodiments of the invention, the polymeric material may be selected to be sufficiently non-reactive with the temperature regulating material so that a desired temperature stabilizing range is maintained.

In some instances, a carrier polymeric material can include a polymer (or a mixture of polymers) that has a partial affinity for a temperature regulating material. For example, the carrier polymeric material can include a polymer (or a mixture of polymers) that is semi-miscible with the temperature regulating material. Such partial affinity can be adequate to facilitate dispersion of the temperature regulating material within the carrier polymeric material at higher temperatures and shear conditions. At lower temperatures and shear conditions, such partial affinity can allow the temperature regulating material to separate out. If a phase change material in a raw form is used, such partial affinity can lead to insolubilization of the phase change material and increased phase change material domain formation within the carrier polymeric material and within the resulting cellulosic fiber. Domain formation can lead to improved thermal regulating properties by facilitating transition of the phase change material between two states. In addition, domain formation can serve to reduce or prevent loss or leakage of the phase change material from the cellulosic fiber during fiber formation or during end use.

### Additives

Depending upon the particular application of the coated article, the coating may further comprise one or more additives, such as, by way of example and not limitation, water, surfactants, dispersants, anti-foam agents (e.g., silicone containing compounds and fluorine containing compounds), thickeners (e.g., polyacrylic acid, cellulose esters and their derivatives, and polyvinyl alcohols), foam stabilizers (e.g., inorganic salts of fatty acids or their sulfate partial esters and anionic surfactants), antioxidants (e.g., hindered phenols and phosphites), thermal stabilizers (e.g., phosphites, organophosphorous compounds, metal salts of organic carboxylic acids, and phenolic compounds), light or UV stabilizers (e.g., hydroxy benzoates, hindered hydroxy benzoates, and hindered amines), microwave absorbing additives (e.g., multifunctional primary alcohols, glycerine, and carbon), reinforcing fibers (e.g., carbon fibers, aramid fibers, and glass fibers), conductive fibers or particles (e.g., graphite or activated carbon fibers or particles), lubricants, process aids (e.g., metal salts of fatty acids, fatty acid esters, fatty acid ethers, fatty acid amides, sulfonamides, polysiloxanes, organophosphorous compounds, silicon containing compounds, fluorine containing compounds, and phenolic polyethers), fire retardants (e.g., halogenated compounds, phosphorous compounds, organophosphates, organobromides, alumina trihydrate, melamine derivatives, magnesium hydroxide, antimony compounds, antimony oxide, and boron compounds), anti-blocking additives (e.g., silica, talc, zeolites, metal carbonates, and organic polymers), anti-fogging additives (e.g., non-ionic surfactants, glycerol esters, polyglycerol esters, sorbitan esters and their ethoxylates, nonyl phenyl ethoxylates, and alcohol ethyoxylates), anti-static additives (e.g., non-ionics such as fatty acid esters, ethoxylated alkylamines, diethanolamides, and ethoxylated alcohol; anionics such as alkylsulfonates and alkylphosphates; cationics such as metal salts of chlorides, methosulfates or nitrates, and quaternary ammonium compounds; and amphoterics such as alkylbetaines), anti-microbials (e.g., arsenic compounds, sulfur, copper compounds, isothiazolins phthalamides, carbamates, silver base inorganic agents, silver zinc zeolites, silver copper zeolites, silver zeolites, metal oxides, and silicates), crosslinkers or controlled degradation agents (e.g., peroxides, azo compounds, and silanes), colorants, pigments, dyes, fluorescent whitening agents or optical brighteners (e.g., bis-benzoxazoles, phenylcoumarins, and bis-(styryl)biphenyls), fillers (e.g., natural minerals and metals such as oxides, hydroxides, carbonates, sulfates, and silicates; talc; clay; wollastonite; graphite; carbon black; carbon fibers; glass fibers and beads; ceramic fibers and beads; metal fibers and beads; flours; and fibers of natural or synthetic origin such as fibers of wood, starch, or cellulose flours), coupling agents (e.g., silanes, titanates, zirconates, fatty acid salts, anhydrides, epoxies, and unsaturated polymeric acids), reinforcement agents, crystallization or nucleation agents (e.g., any material which increases or improves the crystallinity in a polymer, such as to improve rate/kinetics of crystal growth, number of crystals grown, or type of crystals grown), and so forth. The one or more additives may be dispersed uniformly, or non-uniformly, within the coating. Typically, the one or more additives will be selected to be sufficiently non-reactive with the temperature regulating material so that a desired temperature stabilizing range is maintained.

According to some embodiments of the invention, certain treatments or additional coatings may be applied to the coated article to impart properties such as, by way of example and not limitation, stain resistance, water repellency, softer feel, and moisture management properties. Exemplary treatments and coatings include Epic by Nextec Applications Inc., Intera by Intera Technologies, Inc., Zonyl Fabric Protectors by DuPont Inc., Scotchgard by 3M Co., and so forth.

### Manufacturing Methods

Cellulosic fibers in accordance with various embodiments of the invention can be formed using various methods, including, for example, a solution spinning process (wet or dry). In a solution spinning process, one or more cellulosic materials and one or more temperature regulating materials can be delivered to orifices of a spinneret. As one of ordinary skill in the art will understand, a spinneret typically refers to a portion of a fiber forming apparatus that delivers molten, liquid, or dissolved materials through orifices for extrusion into an outside environment. A spinneret typically includes from about 1 to about 500,000 orifices per meter of length of the spinneret. A spinneret can be implemented with holes drilled or etched through a plate or with any other structure capable of issuing desired fibers.

A cellulosic material can be initially provided in any of various forms, such as, for example, sheets of cellulose, wood pulp, cotton linters, and other sources of substantially purified cellulose. Typically, a cellulosic material is dissolved in a solvent prior to passing through the orifices of the spinneret. In some instances, the cellulosic material can be processed (e.g., chemically treated) prior to dissolving the cellulosic material in the solvent. For example, the cellulosic material can be immersed in a basic solution (e.g., caustic soda), squeezed through rollers, and then shredded to form crumbs. The crumbs can then be treated with carbon disulfide to form cellulose xanthate. As another example, the cellulosic material can be mixed with a solution of glacial acetic acid, acetic anhydride, and a catalyst and then aged to form cellulose acetate, which can precipitate from the solution in the form of flakes.

The composition of a solvent used to dissolve a cellulosic material can vary depending upon a desired application of the resulting cellulosic fibers. For example, crumbs of cellulose xanthate as discussed above can be dissolved in a basic solvent (e.g., caustic soda or 2.8 percent sodium hydroxide solution) to form a viscous solution. As another example, precipitated flakes of cellulose acetate as discussed above can be dissolved in acetone to form a viscous solution. Various other types of solvents can be used, such as, for example, a solution of amine oxide or a cuprammonium solution. In some instances, the resulting viscous solution can be filtered to remove any undissolved cellulosic material.

During formation of cellulosic fibers, a temperature regulating material can be mixed with a cellulosic material to form a blend. As a result of mixing, the temperature regulating material can be dispersed within and at least partially enclosed by the cellulosic material. The temperature regulating material can be mixed with the cellulosic material at various stages of fiber formation. Typically, the temperature regulating material is mixed with the cellulosic material prior to passing through the orifices of the spinneret. In particular, the temperature regulating material can be mixed with the cellulosic material prior to or after dissolving the cellulosic material in a solvent. For example, the temperature regulating material can include microcapsules containing a phase change material, and the microcapsules can be dispersed in a viscous solution of the dissolved cellulosic material. In some instances, the temperature regulating material can be mixed with the viscous solution just prior to passing through the orifices of the spinneret.

According to some embodiments of the invention, cellulosic fibers can be formed using a carrier polymeric material. For example, the cellulosic fibers can be formed using powders or pellets formed from the carrier polymeric material having a temperature regulating material dispersed therein. In some instances, the powders or pellets can be formed from a solidified melt mixture of the carrier polymeric material and the temperature regulating material. It is contemplated that the powders or pellets can be initially formed from the carrier polymeric material and can be impregnated or imbibed with the temperature regulating material. It is also contemplated that the powders or pellets can be formed from a dried solution of the carrier polymeric material and the temperature regulating material. During formation of the cellulosic fibers, the powders or pellets can be mixed with a cellulosic material to form a blend at various stages of fiber formation. Typically, the powders or pellets are mixed with the cellulosic material prior to passing through the orifices of the spinneret.

For certain applications, cellulosic fibers can be formed as multi-component fibers. In particular, a first cellulosic material can be mixed with a temperature regulating material to form a blend. The blend and a second cellulosic material can be combined and directed through the orifices of the spinneret in a particular configuration to form respective elongated members of the cellulosic fibers. For example, the blend can be directed through the orifices to form core members or island members, while the second cellulosic material can be directed through the orifices to form sheath members or sea members. Prior to passing through the orifices, the first cellulosic material and the second cellulosic material can be dissolved in the same solvent or different solvents. Portions of the temperature regulating material that are not enclosed by the first cellulosic material can be enclosed by the second cellulosic material upon emerging from the spinneret to reduce or prevent loss or leakage of the temperature regulating material from the resulting cellulosic fibers. It is contemplated that the first cellulosic material need not be used for certain applications. For example, the temperature regulating material can include a polymeric phase change material having a desired transition temperature and providing adequate mechanical properties when incorporated in the cellulosic fibers. The polymeric phase change material and the second cellulosic material can be combined and directed through the orifices of the spinneret in a particular configuration to form respective elongated members of the cellulosic fibers. For example, the polymeric phase change material can be directed through the orifices to form core members or island members, while the second cellulosic material can be directed through the orifices to form sheath members or sea members.

Upon emerging from the spinneret, one or more cellulosic materials typically solidify to form cellulosic fibers. In a wet solution spinning process, the spinneret can be submerged in a coagulation or spinning bath (e.g., a chemical bath), such that, upon exiting the spinneret, one or more cellulosic materials can precipitate and form solid cellulosic fibers. The composition of a spinning bath can vary depending upon a desired application of the resulting cellulosic fibers. For example, the spinning bath can be water, an acidic solution (e.g., a weak acid solution including sulfuric acid), or a solution of amine oxide. In a dry solution spinning process, one or more cellulosic materials can emerge from the spinneret in warm air and solidify due to a solvent (e.g., acetone) evaporating in the warm air.

After emerging from the spinneret, cellulosic fibers can be drawn or stretched utilizing a godet or an aspirator. For example, cellulosic fibers emerging from the spinneret can form a vertically oriented curtain of downwardly moving cellulosic fibers that are drawn between variable speed godet rolls before being wound on a bobbin or cut into staple fiber. Cellulosic fibers emerging from the spinneret can also form a horizontally oriented curtain within a spinning bath and can be drawn between variable speed godet rolls. As another example, cellulosic fibers emerging from the spinneret can be at least partially quenched before entering a long, slot-shaped air aspirator positioned below the spinneret. The aspirator can introduce a rapid, downwardly moving air stream produced by compressed air from one or more air aspirating jets. The air stream can create a drawing force on the cellulosic fibers, causing them to be drawn between the spinneret and the air jet and attenuating the cellulosic fibers. During this portion of fiber formation, one or more cellulosic materials forming the cellulosic fibers can be solidifying. It is contemplated that drawing or stretching of cellulosic fibers can occur before or after drying the cellulosic fibers.

Once formed, cellulosic fibers can be further processed for various fiber applications. In particular, cellulosic fibers in accordance with various embodiments of the invention can be used or incorporated in various products to provide thermal regulating properties to those products. For example, cellulosic fibers can be used in textiles (e.g., fabrics), apparel (e.g., outdoor clothing, drysuits, and protective suits), footwear (e.g., socks, boots, and insoles), medical products (e.g., thermal blankets, therapeutic pads, incontinent pads, and hot/cold packs), personal hygiene products (e.g., diapers, tampons, and absorbent wipes or pads for body care and for baby care), cleaning products (e.g., absorbent wipes or pads for household cleaning, for commercial cleaning, and for industrial cleaning), containers and packagings (e.g., beverage/food containers, food warmers, seat cushions, and circuit board laminates), buildings (e.g., insulation in walls or ceilings, wallpaper, curtain linings, pipe wraps, carpets, and tiles), appliances (e.g., insulation in house appliances), technical products (e.g., filter materials), and other products (e.g., automotive lining material, furnishings, sleeping bags, and bedding).

In some instances, cellulosic fibers can be subjected to, for example, woven, non-woven, knitting, or weaving processes to form various types of plaited, braided, twisted, felted, knitted, woven, or non-woven fabrics. The resulting fabrics can include a single layer formed from the cellulosic fibers, or can include multiple layers such that at least one of those layers is formed from the cellulosic fibers. For example, cellulosic fibers can be wound on a bobbin or spun into a yarn and then utilized in various conventional knitting or weaving processes. As another example, cellulosic fibers can be randomly laid on a forming surface (e.g., a moving conveyor screen belt such as a Fourdrinier wire) to form a continuous, non-woven web of cellulosic fibers. In some instances, cellulosic fibers can be cut into short staple fibers prior to forming the web. One potential advantage of employing staple fibers is that a more isotropic non-woven web can be formed, since the staple fibers can be oriented in the web more randomly than longer or uncut fibers (e.g., continuous fibers in the form of a tow). The web can then be bonded using any conventional bonding process (e.g., a spunbond process) to form a stable, non-woven fabric for use in manufacturing various textiles. An example of a bonding process involves lifting the web from a moving conveyor screen belt and passing the web through two heated calender rolls. One, or both, of the rolls can be embossed to cause the web to be bonded in numerous spots. Carded (e.g., air carded) webs, needle-punched webs, spun-laced webs, air-laid webs, wet-laid webs, as well as spun-laid webs can be formed from cellulosic fibers in accordance with some embodiments of the invention.

It is contemplated that fabrics can be formed from cellulosic fibers including two or more different temperature regulating materials. According to some embodiments of the invention, such combination of temperature regulating materials can exhibit two or more distinct transition temperatures. For example, a fabric for use in a glove can be formed from cellulosic fibers that each includes phase change materials A and B. Phase change material A can have a melting point of about 5° C., and phase change material B can have a melting point of about 75° C. This combination of phase change materials in the cellulosic fibers can provide the glove with improved thermal regulating properties in cold environments (e.g., outdoor use during winter conditions) as well as warm environments (e.g., when handling heated objects such as oven trays). In addition, fabrics can be formed from two or more types of fibers that differ in some fashion (e.g., two or more types of cellulosic fibers with different configurations or cross-sectional shapes or formed so as to include different temperature regulating materials). For example, a fabric can be formed with a certain percentage of cellulosic fibers including phase change material A and a remaining percentage of cellulosic fibers including phase change material B. This combination of cellulosic fibers can provide the fabric with improved thermal regulating properties in different environments (e.g., cold and warm environments). As another example, a fabric can be formed with a certain percentage of cellulosic fibers including a phase change material and a remaining percentage of cellulosic fibers lacking a phase change material. In this example, the percentage of the cellulosic fibers including the phase change material can range from about 10 percent to about 99 percent by weight, such as from about 30 percent to about 80 percent or from about 40 percent to about 70 percent. As a further example, a fabric can be formed with a certain percentage of cellulosic fibers including a phase change material and a remaining percentage of other fibers (e.g., synthetic fibers formed from other polymers) that either include or lack a phase change material. In this example, the percentage of the cellulosic fibers can also range from about 10 percent to about 99 percent by weight, such as from about 30 percent to about 80 percent or from about 40 percent to about 70 percent.

A resulting fabric in accordance with some embodiments of the invention can have a latent heat that is at least about 1 J/g, such as at least about 2 J/g, at least about 5 J/g, at least about 8 J/g, at least about 11 J/g, or at least about 14 J/g. For example, a fabric according to an embodiment of the invention can have a latent heat ranging from about 1 J/g to about 100 J/g, such as from about 5 J/g to about 60 J/g, from about 10 J/g to about 30 J/g, from about 2 J/g to about 20 J/g, from about 5 J/g to about 20 J/g, from about 8 J/g to about 20 J/g, from about 11 J/g to about 20 J/g, or from about 14 J/g to about 20 J/g.

In addition, a resulting fabric in accordance with some embodiments of the invention can exhibit other desirable properties. For example, a fabric (e.g., a non-woven fabric) according to an embodiment of the invention can have one or more of the following properties: (1) a moisture absorbency that is at least 10 gram/gram, such as from about 12 gram/gram to about 35 gram/gram, from about 15 gram/gram to about 30 gram/gram, or from about 18 gram/gram to about 25 gram/gram (expressed as a ratio of a weight of absorbed moisture relative to a moisture-free weight of the fabric under a particular environmental condition); (2) a sink time that is from about 2 seconds to about 60 seconds, such as from about 3 seconds to about 20 seconds or from about 4 seconds to about 10 seconds; (3) a tensile strength that is from about 13 cN/tex to about 40 cN/tex, such as from about 16 cN/tex to about 30 cN/tex or from about 18 cN/tex to about 25 cN/tex; (4) an elongation at break that is from about 10 percent to about 40 percent, such as from about 14 percent to about 30 percent or from about 17 percent to about 22 percent; (5) a shrinkage in boiling water that is from about 0 percent to about 6 percent, such as from about 0 percent to about 4 percent or from about 0 percent to about 3 percent; and (6) a specific weight that is from about 10 g/m² to about 500 g/m², such as about 15 g/m² to about 400 g/m² or from about 40 g/m² to about 150 g/m².

### EXAMPLES

The following examples are illustrative of aspects of the present invention but are not meant to be limiting under 35 U.S.C. §112 of the United States Patent Laws, Article 123(2) of the European Patent Laws or any corresponding national country patent laws concerning the adequacy of the written description. By giving these examples, it is submitted that variations in the scope of the test results and corresponding implementations and claim scope are clearly and unambiguously disclosed to one of skill in the art.

### Example 1

One fabric sample comprised of 70% modacrylic fiber and 30% Outlast Viscose fiber, was tested in accordance with ASTM D 6413-99, “Standard Test Method for Flame Resistance of Textiles (Vertical Test)”. The results were as follows. No after-glow was present on any specimens tested. The Outlast Viscose material is in one embodiment a rayon material or another cellulose based material.

| | | | |
|---|---|---|---|
| | After Flame | Drippings | Char Length |
| Specimen | (sec) | (sec) | (in) |

| | | | | | | |
|---|---|---|---|---|---|---|
| Number | Warp | Fill | Warp | Fill | Warp | Fill |

| | | | | | | |
|---|---|---|---|---|---|---|
| 1 | 0.0 | 0.0 | 0.0 | 0.0 | 5.5 | 6.0 |
| 2 | 0.0 | 0.0 | 0.0 | 0.0 | 4.7 | 4.4 |
| 3 | 0.0 | 0.0 | 0.0 | 0.0 | 5.2 | 3.5 |
| 4 | 0.0 | 0.0 | 0.0 | 0.0 | 4.4 | 3.1 |
| 5 | 0.0 | 0.0 | 0.0 | 0.0 | 4.6 | 3.6 |
| Avg. | 0.0 | 0.0 | 0.0 | 0.0 | 4.9 | 4.1 |

### Example 2

One fabric sample comprised of 68.2% modacrylic fiber and 29.2% Outlast Viscose fiber and 2.5% Spandex, was tested in accordance with ASTM D 6413-99, “Standard Test Method for Flame Resistance of Textiles (Vertical Test)”. The results were as follows. No after-glow was present on any specimens tested.

| | | | |
|---|---|---|---|
| | After Flame | Drippings | Char Length |
| Specimen | (sec) | (sec) | (in) |

| Number | Warp | Fill | Warp | Fill | Warp | Fill |
|---|---|---|---|---|---|---|
| 1 | 0.0 | 0.0 | 0.0 | 0.0 | 4.8 | 3.3 |
| 2 | 0.0 | 0.0 | 0.0 | 0.0 | 5.5 | 4.1 |
| 3 | 0.0 | 0.0 | 0.0 | 0.0 | 4.9 | 4.5 |
| 4 | 0.0 | 0.0 | 0.0 | 0.0 | 4.9 | 3.8 |
| 5 | 0.0 | 0.0 | 0.0 | 0.0 | 4.4 | 3.5 |
| Avg. | 0.0 | 0.0 | 0.0 | 0.0 | 4.9 | 3.8 |

Anti-microbial and anti-fungal testing—both fabrics from examples 1 and 2 above were subjected to AATCC TM100 anti-microbial testing for anti-odor and anti-microbial thresholds. The fabrics were treated with 2% on weight of fabric with Microban® 9200-200 (supplied by Microban International Ltd.) and then washed 25 times. Testing was done using Klebsiella pneumonia, Staphylococcus aureus, organisms. The results of these tests are below:

| | | Result (% Kill) | |
|---|---|---|---|
| | | Klebsiella | Staphylococcus |
| AATCC Test Method 100 | Wash | pneumonia | aureus |
| C0131-OMF 70% Modacrylic | 25 | 99.9 | 99.9 |
| 30% Viscose Outlast Weight | | | |
| 4.5 oz/yd sq. | | | |
| C0130-OMF - 68.2% | 25 | 99 | 99.6 |
| modacrylic 29.2% Viscose | | | |
| Outlast 2.5% Spandex weight | | | |
| 6.3 oz/yd sq. | | | |

### Example 3

This test compares the physiological effect of silk weight short sleeve t-shirts containing fire resistant (FR) modacrylic and Outlast Rayon fibers, with t-shirts containing FR modacrylic & FR Rayon, on human test subjects in a warm environment. The test was conducted at an ambient Temperature of 75° F. (23.9° C.). This test was conducted in an environmental chamber.

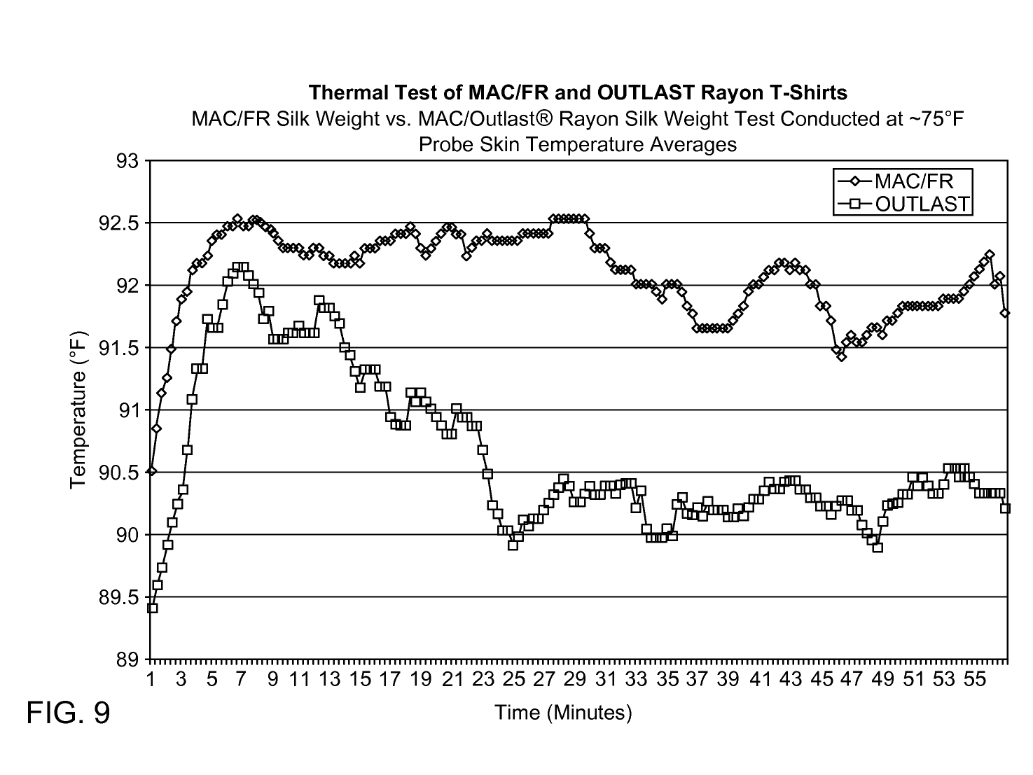

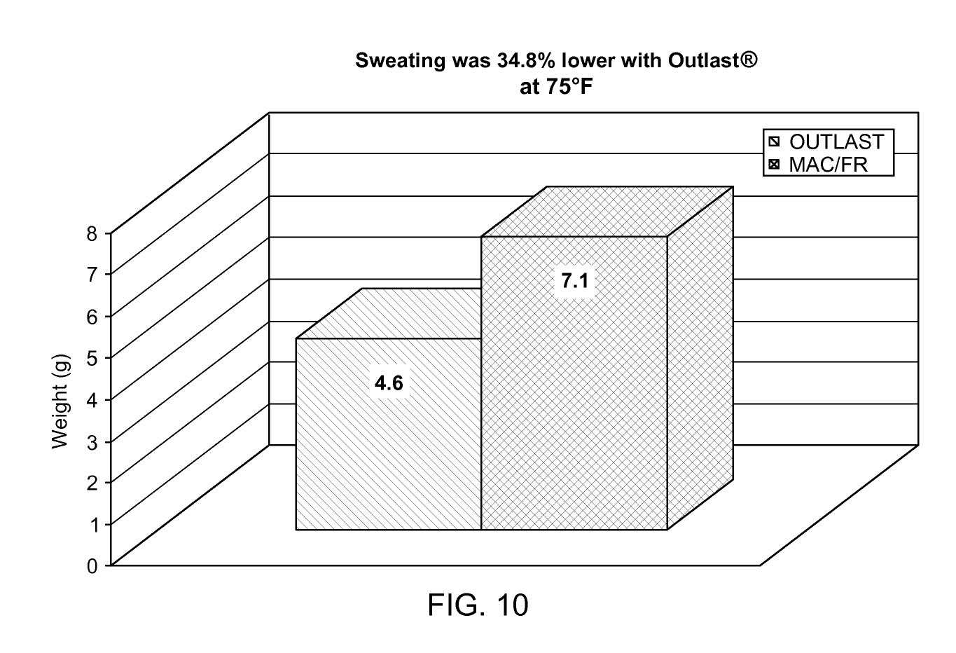

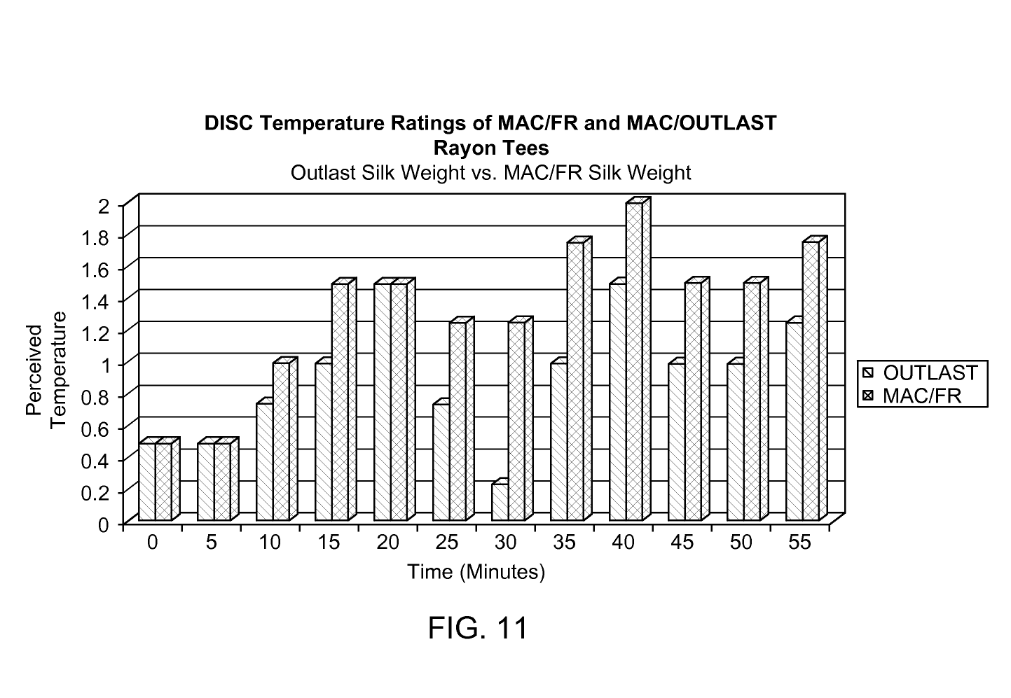

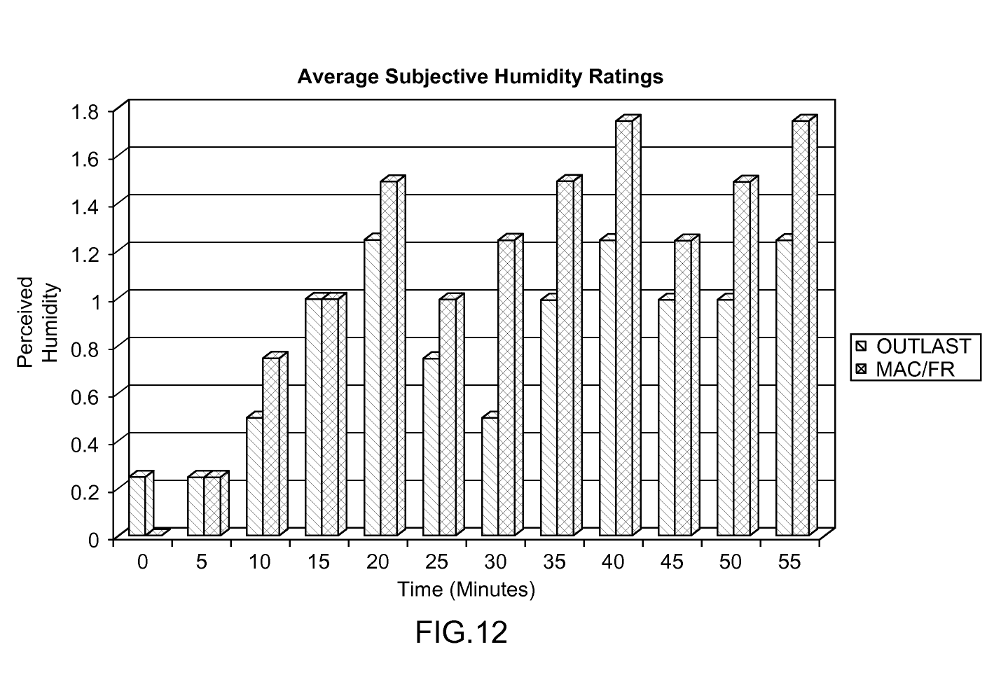

The modacrylic/FR Rayon short sleeve t-shirt is referred to as the “control” shirt in this example. The “Outlast” sample referred to in this example is modacrylic and Outlast Rayon temperature regulating fiber. Both garments subjected to this physiological test, “Control” and “Outlast” passed ASTM D 6413-99 “Standard Test Method for Flame Resistance of Textiles (Vertical Test)”. Based on the simulated environmental testing, conducted as described below, it was found that the Outlast silk weight %-shirt had a considerable beneficial effect on the regulation of skin temperature in warm environments, and a significantly positive effect with regards to both temperature and moisture management in comparison to the Control t-shirt. Details of the testing is shown below and in the attached FIGS. 9-12.

### Configurations Tested

The OUTLAST® tee was of the following construction:
Identification: Style #131 modacrylic OUTLAST Rayon silk weight short sleeve tee
Size: Men's Large
Construction: Modacrylic OUTLAST Rayon intimate blend yarn, in a jersey knit
Weight: 5.7 ounces
   The Control tee was of the following construction:
Identification: a silk weight short sleeve tee in which the OUTLAST Rayon component of the yarn was replaced by FR Rayon, otherwise constructed exactly like the Outlast style #131 Tee
Size: Men's Large
Construction: Modacrylic FR rayon intimate blend yarn, in a jersey knit
Weight: 5.7 ounces

### Test Environment

Testing area was a controlled environmental chamber with an average ambient temperature of 75.0° F.±1.5° F. (23.9° C.±0.83° C.). To ensure consistent comparisons of test results, all tests were conducted under the same controlled environmental conditions and followed the same testing procedures. The test subjects were two healthy males, 20 and 21 years of age. For each of the tests the subjects wore: the test t-shirt, under a long sleeve BOU fatigue uniform shirt (all buttons buttoned), cotton undergarment, cotton jeans, cotton socks, and low-cut walking shoes. The t-shirt was the only item altered on each of the subjects, for each of the tests. Test subjects were not told which of the t-shirts, Control or OUTLAST, was being worn during a given test. The tests were conducted in a controlled environmental chamber with an average ambient temperature of 75.0° F.±1.5° F. (23.9° C.±0.83° C.) and a relative humidity of 50%±5%. A treadmill was used to control walking speed.

### The Tests

1. Six (6) probes were placed on the skin of the torso during each test to record skin temperature and are as follows:
   Center chest below pectoral muscles, on breastbone.
   Left abdomen 1″ above naval.
   Just below the left clavicle, left side of body.
   Most medial point of scapula, center of upper back.
   Center of lower back, 4″ above belt line.
   Mid-side, between armpit and hip.
2. One (1) probe was placed between t-shirt and the skin, with the probe facing the fabric, during each test to record fabric and micro-climate temperature and is as follows:
   Right abdomen 1″ above naval.
3. One (1) micro-climate humidity logger was placed on the breastbone area between the base layer t-shirt and the skin.
4. In addition to the loggers, the t-shirt being tested was weighed before and after each test to determine sweat output.
5. The subjects also recorded a subjective temperature feeling and sweating sensation every five (5) minutes.
6. Each test period was a total of 55 minutes. The skin temperature at each site was recorded every 20 seconds for a total of 165 recordings per test.
7. Each test consisted of six (6) sequential periods as follows:
   a) Minutes 00-05: The test subjects entered the environmental chamber, average ambient temperature of 75° t1.5″F (23.9° to. 83° C.), and sat in a chair to become acclimatized.
   b) Minutes 05-20: The test subjects walked on the treadmill at a speed of 3.0 mph.
   c) Minutes 20-25: The test subjects stopped the treadmill and sat at rest in chair.
   d) Minutes 25-40: The test subjects walked on the treadmill at 3.0 mph in the environmental chamber.
   e) Minutes 40-45: The test subjects stopped the treadmill and sat at rest in chair.
   f) Minutes 45-55: The test subjects walked on the treadmill at 3.0 mph in the environmental chamber.

### Data Analysis

Data analysis was done using ACR Info Logger Software (ACR System Inc.), HOBOware Pro Logger Software (Onset Computer Corporation), and the Microsoft Excel for Office Spreadsheet (Microsoft). Due to the time dependent nature of the insulation capabilities of the fabrics, comparisons were carried out using a time dependent temperature profile. Each tee was worn by both test subjects. For all environmental tests the results from both test subjects were averaged together for Control, and for OUTLAST. This data is charted in the attached graphs.

### Test Results

The graphs shown in FIGS. 8 and 9, “Thermal Test of MAC/FR and OUTLAST Rayon T-Shirts” and “34.8% Reduction in Sweating”, chart the results of the tests conducted. On the temperature graph, the blue line represents the average skin temperature of all probes on the torso while wearing the OUTLAST tee. The red line represents the average skin temperature of all probes on the torso while wearing the Control tee. On the following three graphs, the blue columns represent OUTLAST data, and the red columns represent the Control data. Below is a table highlighting the key data found:

Skin Temperature Averages for the Torso

| | OUTLAST | Control | Difference |
|---|---|---|---|
| Start Temperature | 89.4° F. | 90.5° F. | 1.1° F. |
| Minute 25 | 90.1° F. | 92.4° f. | 2.3° F. |
| Temperature | | | |
| Minute 40 | 90.3° F. | 92.1° F. | 1.8° F. |
| Temperature | | | |
| Minute 55 | 90.3° F. | 92.3° F. | 2.0° F. |
| Temperature | | | |

The thermal test graph indicates measurable differences between the skin temperatures of the wearers of the OUTLAST and Control tees. In addition to the skin temperatures, the test subjects were asked to subjectively evaluate their temperature and sweating sensation comfort level which indicated the OUTLAST t-shirt to be more comfortable in both aspects. The subject's perceived comfort rating was taken from the standardized subjective rating system found in the ASHRAE Handbook, 1997, Thermal Comfort, DISC Ratings, of which 0 is “Comfortable”, 1 is “Uncomfortably Warm, 2 is “Uncomfortably Hot”, and 3 is “Extremely Hot”. The attached graphs, “DISC Temperature Rating of MAC/FR and OUTLAST Rayon Tees” and “Average Subjective Humidity Ratings”, indicate those differences identifying the OUTLAST tee as more comfortable in both temperature and sweating sensation.

Additionally, the amount of moisture accumulation from perspiration within the t-shirt was measured. Results indicate that there was a 34.8% reduction in sweating when wearing the OUTLAST tee in a time period of less than one hour (see “Reduction in Sweating” chart).

### Conclusion

The physiological testing conducted on the tee shirts showed a clear and significant effect on the skin temperatures of the torso between the OUTLAST and Control shirts. The skin surface temperatures started 1.1° F. lower when wearing the OUTLAST shirt. Furthermore, the OUTLAST Rayon temperature regulating technology kept the skin temperature cooler throughout the entire simulated warm environment scenario. Notably, at the 25 minute mark, which was after the first walking series in the protocol, the skin temperature average was 2.3° F. lower while wearing the OUTLAST tee. Likewise, the skin temperature average remained 2.0° F. lower after the second walking series, at the 55 minute mark. Skin surface temperature differences of >2.0° F. are considered to be significant for the entire body as standardized values listed in the ASHRAE Handbook (American Society of Heating, Refrigerating and Air-Conditioning Engineers, Inc.). The OUTLAST silk weight tee demonstrated that the use of OUTLAST temperature regulating technology significantly helps in maintaining a cooler and more stable skin temperature.

There was also a positive effect on the sweat production when wearing the OUTLAST tee. The OUTLAST tee resulted in a 34.8% reduction in sweating. Thus, the OUTLAST temperature regulating technology decreases perspiration as well minimizes the rising of the skin temperature in silk weight tees.

The subjective ratings also demonstrated a significant benefit when wearing the OUTLAST tee, compared with the Control tee. The OUTLAST tee was rated as more comfortable in regards to temperature regulation and sweating sensation in the warm environment. Thus, this supports the objective temperature data described earlier.

In summary, the results of the physiological testing conducted on the t-shirts demonstrates that the OUTLAST temperature regulating technology used in a silk weight tee has a performance and comfort advantage over the Control MAC/FR short sleeve tee.

### Example 4

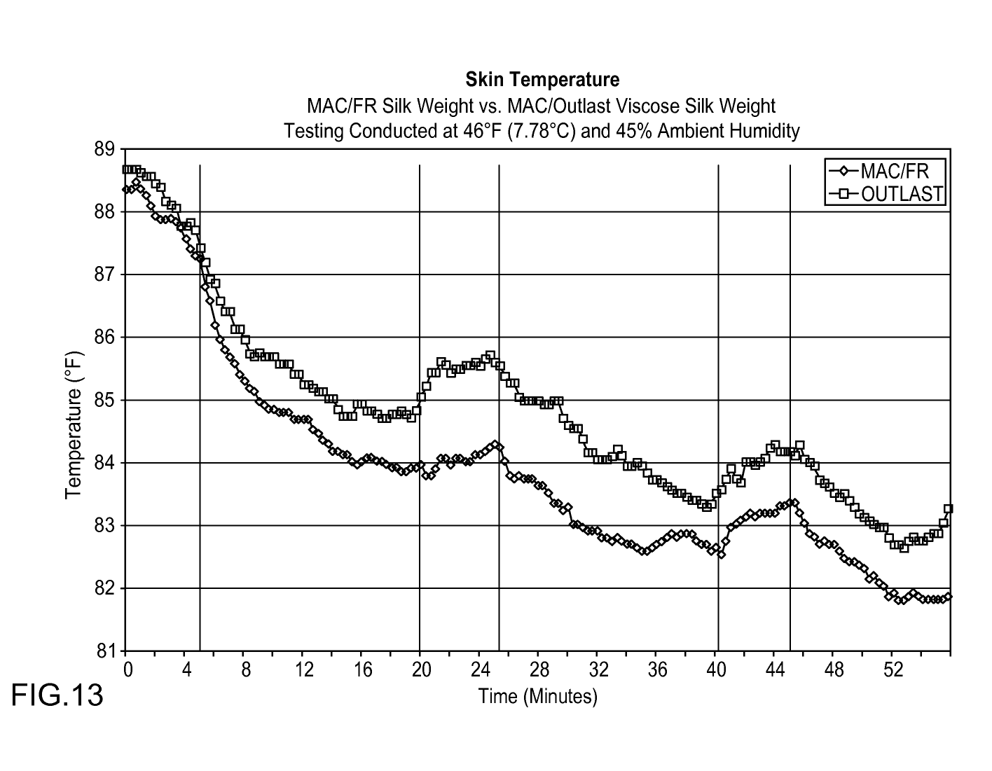

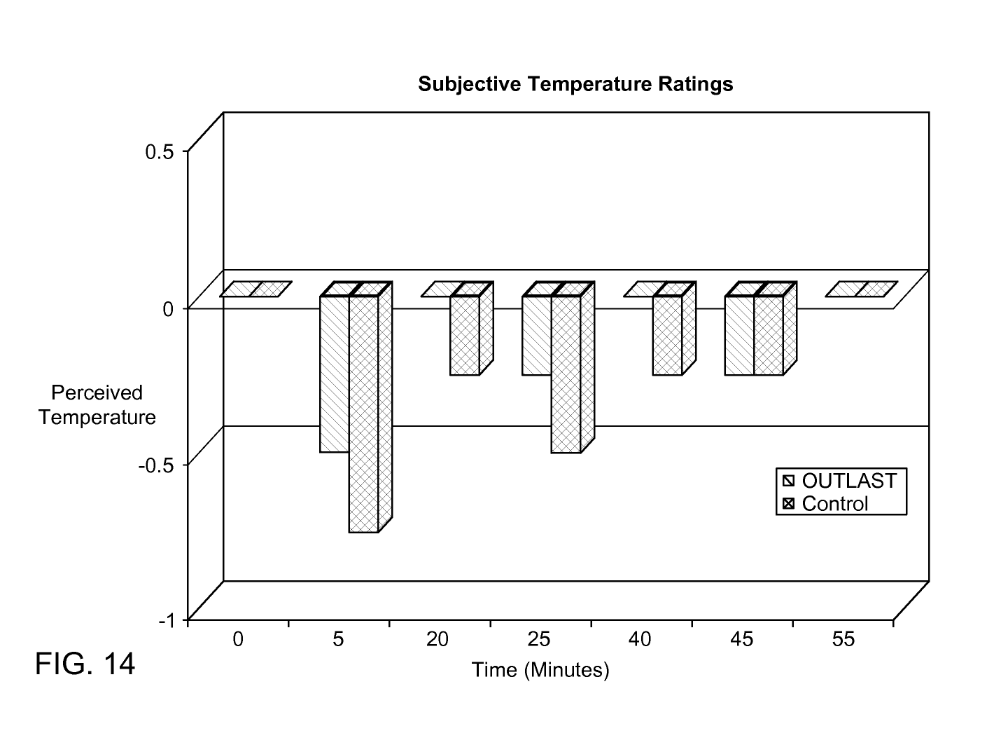

This test determined the physiological performance comparison of flame resistant (FR) T-Shirts conducted at an ambient Temperature of 46° F. The test was a human-subject test conducted in an environmental chamber. The report shows that under the conditions of the test, when compared with the Control t-shirt, the Outlast t-shirt provided up to 2° F. warmer skin temperature, lower humidity within the shirt, and 75% less sweating that was verified subjectively by the test subjects. FIGS. 13-15 show results of these tests.

### Introduction

This test was performed to compare the physiological effects of silk weight short sleeve t-shirts containing modacrylic & Outlast Rayon, against t-shirts containing modacrylic & FR Rayon, on human test subjects in a cold environment. The modacrylic FR rayon short sleeve t-shirt is referred to as the “Control” t-shirt throughout this report; the modacrylic OUTLAST Rayon short sleeve t-shirt is referred to as the “OUTLAST” t-shirt. Both test garments involved in this study, “Control” & “OUTLAST”, pass ASTM D 6413-99 “Standard Test Method for Flame Resistance of Textiles (Vertical Test)”. Based on the simulated environmental testing, conducted as described below, it was found that the OUTLAST t-shirt had statistically beneficial effect on the regulation of skin temperature in a cold environment, and a positive effect in regards to subjective comfort, temperature, and moisture management in comparison to the Control t-shirt.

### Objective

To test and compare the thermal effectiveness, subjective thermal comfort, and perspiration management of a modacrylic FR rayon short sleeve t-shirt against a modacrylic OUTLAST Rayon short sleeve t-shirt, in a cold environment.

### Configurations Tested

The OUTLAST t-shirt was of the following construction:
Identification: Style #131 modacrylic OUTLAST Rayon silk weight short sleeve t-shirt
Size: Men's Large
Construction: Modacrylic OUTLAST® Rayon intimate blend yarn, in a jersey knit
Weight: 5.7 ounces
   The Control t-shirt was of the following construction:
Identification: A silk weight short sleeve t-shirt in which the “OUTLAST Rayon” component of the yarn was replaced by “FR Rayon”, otherwise constructed exactly like the Style #131 t-shirt
Size: Men's Large
Construction: Modacrylic FR rayon intimate blend yarn, in a jersey knit
Weight: 5.7 ounces

### Test Environment

Testing area was a controlled environmental chamber with an average ambient temperature of 46° F.±3° F. (7.8°±1.7° C.) and an ambient relative humidity of 45%±2.5%. To ensure consistent comparisons of test results all tests were conducted under the same controlled environmental conditions and followed the same testing procedures.
The test subjects were two healthy males, 20 and 21 years of age.
For each of the respective tests the subjects wore:
One of the two test t-shirts*
A long sleeve standard military issue Battle Dress Uniform (BDU) fatigue shirt, with the sleeves down and all buttons buttoned
Briefs, cotton jeans, cotton socks, and low-cut walking shoes.
   *The t-shirts were the only item altered on each of the subjects, for each of the tests.

Test subjects were not told which of the t-shirts, Control or OUTLAST, was being worn during a given test. A treadmill was used to control walking speed at 3.0 Miles per Hour (MPH).

### Test Protocol

1. Six (6) temperature probes were placed on the surface of the skin during each test to record the subject's skin temperatures at the following locations:
   i. Center of the chest, on the sternum.
   ii. Left abdomen, approximately 1″ above and 1″ to the Left of the naval.
   iii. Left chest on the pectoral area.
   iv. Center of upper back, approximately 2″ below the neckline of the t-shirt.
   v. Center of lower back, approximately 4″ above beltline.
   vi. Left mid-side, between armpit and hip.
2. One (1) micro-climate relative humidity logger was placed on the breastbone area between the t-shirt and the skin, as indicated by the blue square on the torso diagram.
3. The skin temperatures at each site and the micro-climate relative humidity were recorded every 20 seconds for a total of 1155 data points per test.
4. The t-shirts were weighed immediately before and after each test session to determine sweat output.
5. The subjects reported subjective temperature comfort and sweating sensation at seven specific time intervals during each test.
6. Each test was a total of 55 minutes and consisted of six (6) sequential intervals as follows:
Minute 00:00-05:00: The test subjects entered the environmental chamber and sat upright in a chair to become acclimatized
Minute 05:00-20:00: The test subjects walked on a treadmill at a speed of 3.0 mph
Minute 20:00-25:00: The test subjects sat at rest in a chair
Minute 25:00-40:00: The test subjects walked on a treadmill at a speed of 3.0 mph
Minute 40:00-45:00: The test subjects sat at rest in a chair
Minute 45:00-55:00: The test subjects walked on a treadmill at a speed of 3.0 mph

### Data Analysis

Data capture and analysis was performed using ACR Info Logger Software (ACR System Inc.), HOBOware Pro Logger Software (Onset Computer Corporation), and Microsoft Excel for Office Spreadsheet (Microsoft). For all tests the results from both test subjects skin surface temperatures and micro-climate relative humidity were averaged together respectively for the Control and OUTLAST t-shirts. This data is charted in the attached graphs shown in FIGS. 13-15.

### Test Results

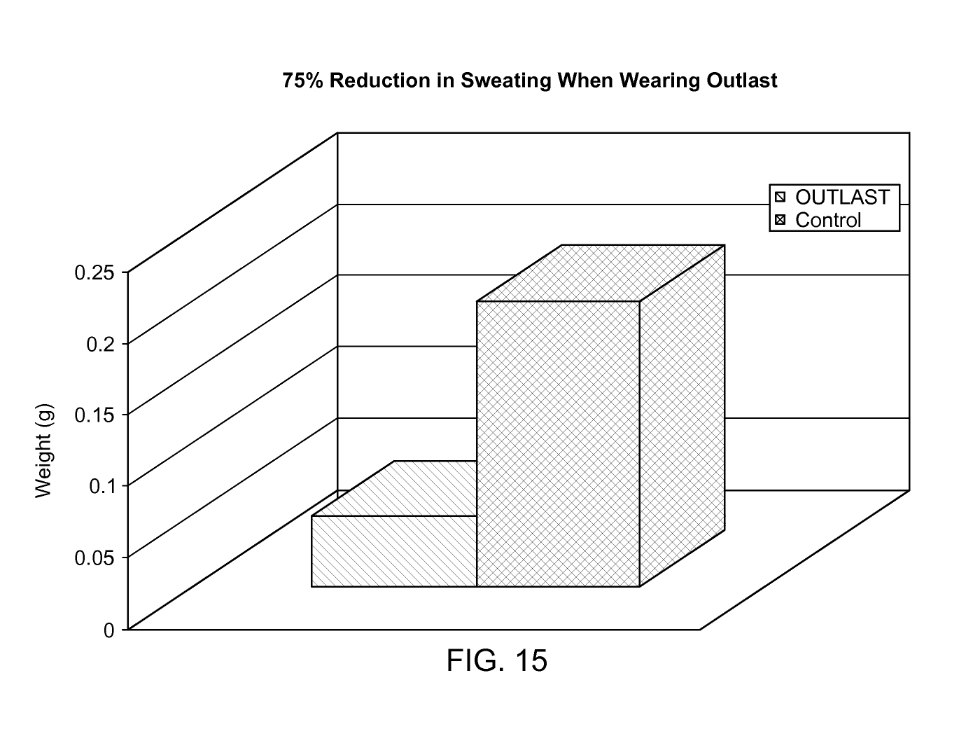

The attached, “Skin Temperature”, charts (FIG. 13) the results of the testing conducted. One line represents the average skin temperature of all probes on the torso while wearing the OUTLAST t-shirt. The other line represents the average skin temperature of all probes on the torso while wearing the Control t-shirt. The graph indicates measurable differences between the skin temperatures of the test subjects when wearing the OUTLAST versus the Control t-shirts. Measured skin temperature difference is further shown to be significant through the “Subjective Temperature Ratings” (see FIG. 13) the Outlast shirt generally felt more comfortable. Moisture accumulation from sweating was measured by weighing the clean, dry t-shirts before the beginning of each test, and again after each test was complete. The measured difference in weight is sweat production. Results show that even in a cold environment there was a very significant reduction in sweating when wearing the OUTLAST t-shirt as compared to the Control t-shirt (FIG. 15) “75% Reduction in Sweating When Wearing Outlast”. The perceived comfort rating followed a standardized subjective rating system similar to the ASHRAE Handbook, 1997, Thermal Comfort, DISC Ratings. Zero (0) was ranked as Comfortable”, −1 as “Slightly Cool”, −2 as “Cold”, and −3 is “Very Cold”.

### CONCLUSIONS

The physiological testing comparing the two t-shirts showed a clear and significant effect on the skin temperatures of the torso between the OUTLAST and Control t-shirts. The OUTLAST Rayon temperature regulating technology kept the skin temperature warmer and more comfortable throughout the entire simulated cold environment scenario. Skin surface temperature differences of >2.0° F. are considered to be significant for the entire body as standardized values listed in the ASHRAE Handbook (American Society of Heating, Refrigerating and Air-Conditioning Engineers, Inc.). The OUTLAST Silk weight %-shirt demonstrated that the use of OUTLAST temperature regulating technology significantly helps in maintaining a more stable skin temperature. There was also a positive effect on the microclimate of the test subjects while wearing the OUTLAST shirt, exhibited as a decrease in sweat production. In colder environments sweating can lead to accelerated chilling of the body, even hypothermia and potentially death. In this test, both test subjects experienced a sweating spike with the Control shirt during the rest periods; but extreme sweating was not experienced while wearing the OUTLAST t-shirt, where measured perspiration was 75% less. Thus, the OUTLAST temperature regulating technology decreased perspiration as well sustaining warmer skin temperatures. The differences in skin temperature measured in this physiological test were supported by the subjective ratings of the test subjects. In a blind comparison, the OUTLAST t-shirt was rated as more comfortable in regards to temperature regulation and sweating sensation over the Control. In summary, the results of the physiological testing conducted on the t-shirts demonstrates that the OUTLAST temperature regulating technology used in a silk weight %-shirt has a performance and comfort advantage over the Control modacrylic FR rayon short sleeve t-shirt in a cold environment.

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A fabric, comprising:
a plurality of fiber bodies, wherein between 20-50% of the plurality of fiber bodies comprise a first fiber material and wherein between 50-80% of the plurality of fiber bodies comprise a second fiber material,
wherein the first fiber material comprises a cellulosic material and a non-encapsulated phase change material dispersed in the cellulosic material, the non-encapsulated phase change material forming a plurality of domains dispersed in the cellulosic material, the non-encapsulated phase change material having a latent heat of at least 5 Joules per gram and a transition temperature in the range of 0° C. to 100° C., the non-encapsulated phase change material providing thermal regulation based on at least one of absorption and release of the latent heat at the transition temperature;
wherein the second fiber material comprises a fire resistant material.

2. The fabric of claim 1, wherein the non-encapsulated phase change material is a polymeric phase change material.

3. The fabric of claim 1, wherein the non-encapsulated phase change material is a functional polymeric phase change material.

4. The fabric of claim 1, wherein the cellulosic material is viscose.

5. The fabric of claim 1, wherein the cellulosic material is selected from the group consisting of leaves, wood, bark and cotton.

6. The fabric of claim 1, wherein the fire resistant material is selected from the group consisting of modacrylic, nomex, Kevlar, twaron, rayon, PBI, treated cotton, melamine fibers, and glass fibers.

7. The fabric of claim 1, wherein the fabric contains between 30-35% of the modacrylic material.

8. The fabric of claim 1, wherein the fabric contains between 25-40% of the modacrylic material.

9. The fabric of claim 1, wherein the fabric contains between 55-65% of the first fiber material.

10. The fabric of claim 1, wherein the fabric contains between 65-75% of the first fiber material.

11. A fabric or yarn comprising:
a plurality of fiber bodies, wherein between 20-50% of the plurality of fiber bodies comprise a first fiber material and wherein between 50-80% of the plurality of fiber bodies comprise a second fiber material,
wherein the first fiber material comprises a cellulose polymer material and a non-encapsulated phase change material dispersed in the cellulose polymer material, the non-encapsulated phase change material forming a plurality of domains dispersed in the cellulose polymer material, the non-encapsulated phase change material having a latent heat of at least 5 Joules per gram and a transition temperature in the range of 0° C. to 100° C., the non-encapsulated phase change material providing thermal regulation based on at least one of absorption and release of latent heat at the transition temperature; and
wherein the second fiber material comprises a fire resistant material.

12. The fiber of claim 11, wherein the non-encapsulated phase change material is a polymeric phase change material.

13. The fiber of claim 11, wherein the non-encapsulated phase change material is a functional polymeric phase change material.

14. The fiber of claim 11, wherein the cellulosic material is viscose.

15. The fiber of claim 11, wherein the cellulosic material is selected from the group consisting of leaves, wood, bark and cotton.

16. The fiber of claim 11, wherein the fire resistant material is selected from the group consisting of modacrylic, nomex, Kevlar, twaron, rayon, PBI, treated cotton, melamine fibers, and glass fibers.

17. The fiber of claim 11, wherein the fiber contains between 30-35% of the modacrylic material.

18. The fiber of claim 11, wherein the fiber contains between 25-40% of the modacrylic material.

19. The fiber of claim 11, wherein the fiber contains between 55-65% of the first fiber material.

20. A fabric, fiber or yarn comprising:
a plurality of fiber bodies, wherein between 20-50% of the plurality of fiber bodies comprise a first fiber material and wherein between 50-80% of the plurality of fiber bodies comprise a second fiber material,
wherein the first fiber material comprises a cellulose polymer material and a micro-encapsulated phase change material dispersed in the cellulose polymer material, the micro-encapsulated phase change material having a latent heat of at least 5 Joules per gram and a transition temperature in the range of 0° C. to 100° C., the micro-encapsulated phase change material providing thermal regulation based on at least one of absorption and release of latent heat at the transition temperature; and
wherein the second fiber material comprises a fire resistant material.
